(19) United States
(12) Patent Application Publication
(10) Pub. No.: US 2024/0142584 A1
(43) Pub. Date: May 2, 2024

(54) LIDAR TIME-OF-FLIGHT SIGNAL PROCESSING

(71) Applicant: OSRAM GmbH, München (DE)

(72) Inventors: Gerhard Maierbacher, München (DE); Florian Kolb, Jena (DE); Martin Schnarrenberger, Berlin (DE)

(21) Appl. No.: 18/262,845

(22) PCT Filed: Dec. 20, 2021
(86) PCT No.: PCT/EP21/86713

§ 371 Date: Jul. 25, 2023

(30) Foreign Application Priority Data
Jan. 27, 2021 (DE) 10 2021 101 790.4

(51) Int. Cl. G01S 7/4865; G01S 7/4861; G01S 7/487

(52) U.S. Cl. CPC G01S 7/4865; G01S 7/4861; G01S 7/487

(57) ABSTRACT

In embodiments a detection system includes a detector configured to provide a received signal and a processing circuit configured to provide a plurality of quantized signals, each quantized signal being associated with a respective threshold level, and each quantized signal being representative of portions of the received signal in which a signal level of the received signal is greater than the respective threshold level and to provide an encoded signal based on the plurality of quantized signals, the encoded signal including a first plurality of first encoded signal values being representative of the portions of the received signal in which the signal level of the received signal becomes greater than one of the threshold levels, and a second plurality of second encoded signal values being representative of the portions of the received signal in which the signal level of the received signal becomes less than one of the threshold levels.

### CROSS-REFERENCE TO RELATED APPLICATIONS

This patent application is a national phase filing under section 371 of PCT/EP2021/086713, filed Dec. 20, 2021, which claims the priority of German patent application 10 2021 101 790.4, filed Jan. 27, 2021, each of which is incorporated herein by reference in its entirety.

### TECHNICAL FIELD

Various aspects are related to a detection system and methods thereof (e.g., a method of detecting a signal), and various aspects are related to a LIDAR (“Light Detection and Ranging”) system including a detection system.

### BACKGROUND

Light detection and ranging is a sensing technique that is used, for example, in the field of autonomous driving for providing detailed information about the surrounding of an automated or partially automated vehicle. Light is used to scan a scene and determine the properties (e.g., the location, the speed, the direction of motion, and the like) of the objects present therein. A LIDAR system typically uses the time-of-flight (ToF) of the emitted light to measure the distance to an object. A LIDAR system may include one of a high-speed analog-to-digital converter (ADC) or a time-to-digital converter (TDC) for processing the light received from the scene. An ADC-based solution may provide amplitude information, which may be useful for object detection and object fusion (the respective algorithms may make use of amplitude information). In addition, in an ADC-based solution, the signal-to-noise ratio may be derived, which may provide a measure of how reliable the measurement was. However, a high-speed ADC may be expensive in terms of power consumption, heat, cost, complexity, etc. Furthermore, the continuous full waveform sampling at high sampling rates generates large amounts of data which need to be communicated and processed. In addition, not all detectors provide amplitude information (e.g., single photon avalanche diode (SPAD) detectors do not provide such information). A LIDAR architecture adopting a TDC approach may have various advantages with respect to an ADC approach: (1) a simple system setup that reduces the number of expensive components while being suitable for high-speed implementations; (2) compared to waveform sampling solutions no high-speed ADC is needed, which may be beneficial with respect to power consumption and cost; and (3) in view of the event-based nature of a TDC detection scheme the amount of generated data may be relatively small, thus reducing the amount of data to process (illustratively, less CPU load is generated) and reducing the needed CPU-power, which leads to a decrease in the power consumption and cost of the system.

However, a limitation of a usual TDC-based system is that it does not provide detailed information about the properties of a light signal, e.g. pulse-amplitude and/or pulse-shape information. An approach including a plurality of comparators each providing its output to a respective time-to-digital converter is described in U.S. Ser. No. 10/802,120 B1.

### SUMMARY

Various aspects may be related to a detection system configured according to a time-to-digital conversion approach and adapted to determine additional information (e.g., amplitude and/or shape information) associated with a detected signal, which are not determined in a conventional TDC-based detection system. Various aspects are related to a detection system configured to process a received signal in a way that, compared to a conventional TDC-approach, enables extraction of amplitude and/or shape information (e.g., in addition to time-of-flight information). The detection system described herein may be configured to process a received signal in such a way that upon time-to-digital conversion of the processed signal the resulting digitized (in other words, digital) signal enables determining the additional information. The TDC-approach described herein may also be referred to in the following as adapted TDC-approach.

Various aspects may be related to a method of processing a received signal that, compared to a conventional TDC-based processing, enables determining additional information associated with the received signal (e.g., amplitude and/or shape information). The method described herein may be configured to provide a digitized representation of the received signal via time-to-digital conversion in an adapted manner that provides that amplitude and/or shape information may be determined from the digitized representation.

The additional information provided by the adapted TDC-strategy described herein may be advantageous, for example, for determining the reflectance or other surface properties of an object. As another example, the strategy described herein may be advantageous for signal averaging and advanced signal processing purposes, and/or for interfering signal detection and crosstalk rejection. As a further example, the strategy described herein may be advantageous for other subsequent processing steps like object detection, object tracking, and sensor fusion stages.

In the context of the present description, reference may be made to the detection and processing of a “signal”. The “signal” may be or may include any type of analog signal for which the adapted TDC-approach described herein may be applied. The detection system and the method of processing described herein may be used for different types of analog signals, such as a light signal, an ultrasound signal, a RADAR signal, a radiofrequency signal, as examples. Particular reference may be made to detection and processing of a “light signal”, e.g. in the context of LIDAR applications. It is however understood that a light signal is only an example used to illustrate a possible application of the adapted TDC-approach described herein.

In the context of the present description, reference may be made to amplitude and/or shape information to describe the “additional information” that the adapted TDC-approach may provide. It is however understood that the processing described herein may also provide that other type of signal-related information may be extracted from a determined digitized signal, such as an oscillation frequency of a periodic signal modulated onto the pulse, or a number of pulses included in the signal, or the number and relative amplitude of pulses in a multi-pulse signal, as other examples.

In the context of the present description, reference may be made to a LIDAR system, which may include the detection system described herein. A LIDAR system may include various components and sensors for monitoring a scene (e.g., an environment surrounding a vehicle), as commonly known in the art. By way of example, a LIDAR system may include a brightness sensor, a presence sensor, an optical camera, a RADAR sensing system, an ultrasonic sensing system, and/or a light-based sensing system.

A LIDAR system may include one or more actuators for adjusting the environmental surveillance conditions, e.g. one or more actuators for adapting the emission direction of light, for adapting the orientation of an optical camera, for adapting the emission direction of ultrasonic waves, and the like. A LIDAR system may include a data processing circuit for processing the data provided by the sensors. The data processing circuit may include, for example, a sensor fusion module for combining the data provided by different types of sensors and enhancing the monitoring of the scene. The data processing circuit may be configured to carry out object recognition and/or object classification to analyze the object(s) present in the monitored scene. The object recognition and/or object classification may be based on the data provided by the sensors (e.g., by one or more of the available sensors). A LIDAR system may include one or more memories storing information and instructions, such as the sensed data, the determined object information, instructions on how to operate the sensors, and the like. A LIDAR system may include one or more communication interfaces to communicate with other systems (e.g., other systems of a same vehicle, or another LIDAR system of another vehicle, as examples), e.g. configured for wired- and/or wireless-communication.

It is understood that a LIDAR system is an example of a possible application of the adapted TDC-based detection strategy described herein. The method and the detection system described herein may also be for use in other types of application or systems in which determining additional information (e.g., amplitude and/or shape) of a signal may be advantageous, for example in an optical transmission system (e.g., wireless or including optical fibers), e.g. in a system in which data and information may be transmitted by means of light. The method and the detection system described herein may be for use in applications in which a time-based detection of a short signal (e.g., with a duration less than 500 ns, or less than 100 ns) is to be provided. The high-speed temporal signal capturing capabilities combined with the amplitude/pulse-shape reconstruction features provide the means to capture, store, and process high-speed signals with an arbitrary waveform. This may be particularly relevant in applications where high-speed ADC solutions are either too costly, too complex to implement, or simply not yet fast enough. Potential applications may range from detectors that are used in particle accelerators to low-cost signal capturing applications in the consumer and automotive domain.

In various aspects, a detection system may include: a detector configured to provide a received signal; and a processing circuit configured to: provide a plurality of quantized signals, each quantized signal being associated with a respective threshold level, and each quantized signal being representative of the portions of the received signal in which a signal level of the received signal is greater than the respective threshold level; provide an encoded signal based on the plurality of quantized signals, the encoded signal including a first plurality of first encoded signal values being representative of the portions of the received signal in which the signal level of the received signal becomes greater than one of the threshold levels, and including a second plurality of second encoded signal values being representative of the portions of the received signal in which the signal level of the received signal becomes less than one of the threshold levels; and perform a time-to-digital conversion of the encoded signal to provide a digitized signal, the digitized signal including a first plurality of first digitized values associated with the first encoded signal values, and including a second plurality of second digitized values associated with the second encoded signal values.

In various aspects, a detection system may include: a detector configured to provide a received signal; and a processing circuit configured to: encode the shape of the received signal, based on the slope of the received signal, to provide an encoded signal, the encoded signal including a first plurality of first encoded signal values being representative of the portions of the received signal in which a slope of a tangent to the received signal is positive, and a second plurality of second encoded signal values being representative of the portions of the received signal in which the slope of the tangent to the received signal is negative; and perform a time-to-digital conversion of the encoded signal to provide a digitized signal, the digitized signal including a first plurality of first digitized values associated with the first encoded signal values, and including a second plurality of second digitized values associated with the second encoded signal values.

In various aspects, a detection system may include: a detector 15 configured to provide a received signal; and a processing circuit configured to: encode the signal level of the received signal, based on a plurality of threshold values, to provide an encoded signal, the encoded signal including a first plurality of first encoded signal values being representative of the portions of the received signal in which a signal level of the received signal becomes greater than one threshold value of the plurality of threshold values, and including a second plurality of second encoded signal values being representative of the portions of the received signal in which the signal level of the received signal becomes less than one threshold value of the plurality of threshold values; and perform a time-to-digital conversion of the encoded signal to provide a digitized signal, the digitized signal including a first plurality of first digitized values associated with the first encoded signal values, and including a second plurality of second digitized values associated with the second encoded signal values.

In various aspects, a method of detecting a signal may include: providing a received signal; providing a plurality of quantized signals, each quantized signal being associated with a respective threshold level, and each quantized signal being representative of the portions of the received signal in which a signal level of the received signal is greater than the respective threshold level; providing an encoded signal based on the plurality of quantized signals, the encoded signal including a first plurality of first encoded signal values being representative of the portions of the received signal in which the signal level of the received signal becomes greater than one of the threshold levels associated with the quantized signals, and including a second plurality of second encoded signal values being representative of the portions of the received signal in which the signal level of the received signal becomes less than one of the threshold levels associated with the quantized signals; and performing a time-to-digital conversion of the encoded signal to provide a digitized signal, the digitized signal including a first plurality of first digitized values associated with the first encoded signal values, and including a second plurality of second digitized values associated with the second encoded signal values.

The expression “signal level” may be used herein to describe a parameter associated with a signal or with a portion of a signal (e.g., with a peak). A “signal level” as used herein may include at least one of a power level, a current level, a voltage level, or an amplitude level (also referred to herein as amplitude).

The term “amplitude” may be used herein to describe the height of a peak, e.g. the height of a pulse. The term “amplitude” may describe the signal level of the signal at the peak with respect to a reference value for the signal level. The term “amplitude” may be used herein also in relation to a signal that is not a symmetric periodic wave, e.g. also in relation to an asymmetric wave (for example in relation to a signal including periodic pulses in one direction). In this regard, the term “amplitude” may be understood to describe the amplitude of the signal (e.g., of the peak) as measured from the reference value of the signal level.

The term “processor” as used herein may be understood as any kind of technological entity that allows handling of data. The data may be handled according to one or more specific functions executed by the processor. Further, a processor as used herein may be understood as any kind of circuit, e.g., any kind of analog or digital circuit. A processor may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the 10 respective functions, which will be described below in further detail, may also be understood as a processor or logic circuit. It is understood that any two (or more) of the processors or logic circuits detailed herein may be realized as a single entity with equivalent functionality or the like, and conversely that any single processor or logic circuit detailed herein may be realized as two (or more) separate entities with equivalent functionality or the like.

The term “calculate” as used herein encompasses both ‘direct’ calculations via a mathematical expression/formula/relationship and ‘indirect’ calculations via lookup or hash tables and other array indexing or searching operations.

The terms “differential”, “differentiate”, and “differentiated” may be used herein as commonly understood in their mathematical sense, to indicate an operation in which a derivative of a function is determined. The terms “differential”, “differentiate”, and “differentiated” may be used herein in relation to the processing of a signal to indicate an operation in which variations in the signal level of the signal (e.g., in its amplitude) over time are determined, e.g. an operation in which variations in the slope of the signal over time are determined.

### BRIEF DESCRIPTION OF THE DRAWINGS

In the drawings, like reference characters generally refer to the same parts throughout the different views. The drawings are not necessarily to scale, emphasis instead generally being placed upon illustrating the principles disclosed herein. In the following description, various aspects disclosed herein are described with reference to the following drawings, in which:

FIG. 1A, FIG. 1B, FIG. 1C, FIG. 1D, and FIG. 1E each shows schematically a detection system according to various aspects;

FIG. 1F shows a timing diagram associated with a time measurement according to various aspects;

10 FIG. 1G shows a timing diagram associated with a time measurement according to various aspects;

FIG. 2A shows a detector and a graph associated with a received signal according to various aspects;

FIG. 2B shows a quantization stage and a graph associated with a quantized signal according to various aspects;

FIG. 2C shows an encoding stage and a graph associated with a cumulated signal according to various aspects;

FIG. 2D shows an encoding stage and a graph associated with a differentiated signal according to various aspects;

FIG. 2E shows an encoding stage and a graph associated with an encoded signal according to various aspects;

FIG. 2F shows a digitalization stage and a graph associated with a digitized signal according to various aspects;

FIG. 3A, FIG. 3B, FIG. 3C, and FIG. 3D each shows a respective graph associated with signal shape inference according to various aspects;

FIG. 3E shows a series of graphs associated with signal processing according to various aspects;

FIG. 4 shows a LIDAR system in a schematic view according to various aspects;

FIG. 5A shows a LIDAR system in a schematic view according to various aspects;

FIG. 5B shows an analog signal processing stage in a schematic view according to various aspects;

FIG. 5C shows a digital signal processing stage in a schematic view according to various aspects;

FIG. 5D shows a digital signal processing stage in a schematic view according to various aspects;

FIG. 5E shows a fine time-to-digital conversion stage in a schematic view according to various aspects; and

FIG. 6 shows a tapped delay line in a schematic view according to various aspects.

### DETAILED DESCRIPTION OF ILLUSTRATIVE EMBODIMENTS

The following detailed description refers to the accompanying drawings that show, by way of illustration, specific details and implementations in which the aspects disclosed herein may be practiced. These aspects are described in sufficient detail to enable those skilled in the art to practice the disclosed implementations. Other aspects may be utilized and structural, logical, and electrical changes may be made without departing from the scope of the disclosed implementations. The various aspects are not necessarily mutually exclusive, as some aspects may be combined with one or more other aspects to form new aspects. Various aspects are described in connection with methods and various aspects are described in connection with devices (e.g., a detection system, a processing circuit, a detector, etc.). However, it is understood that aspects described in connection with methods may similarly apply to the devices, and vice versa.

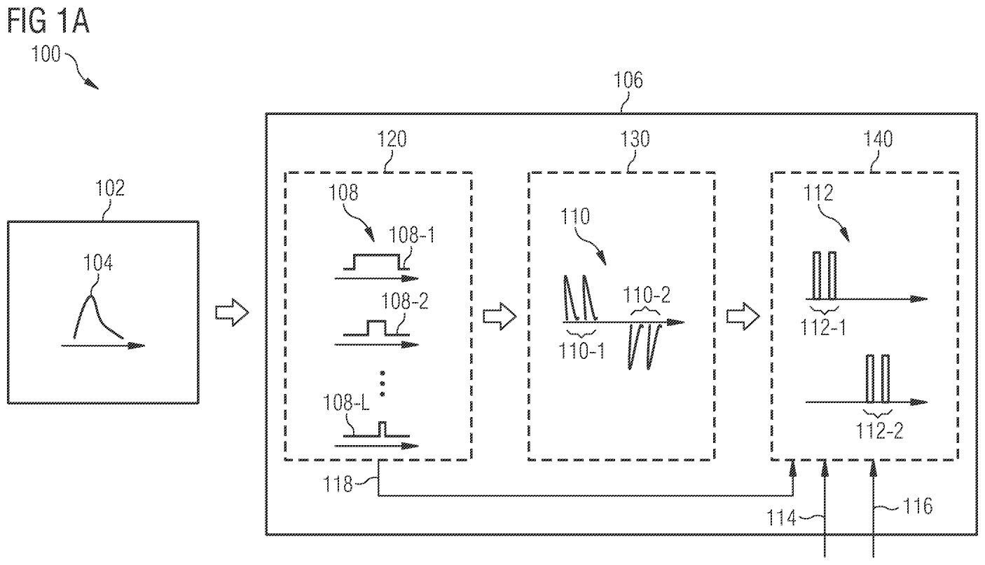

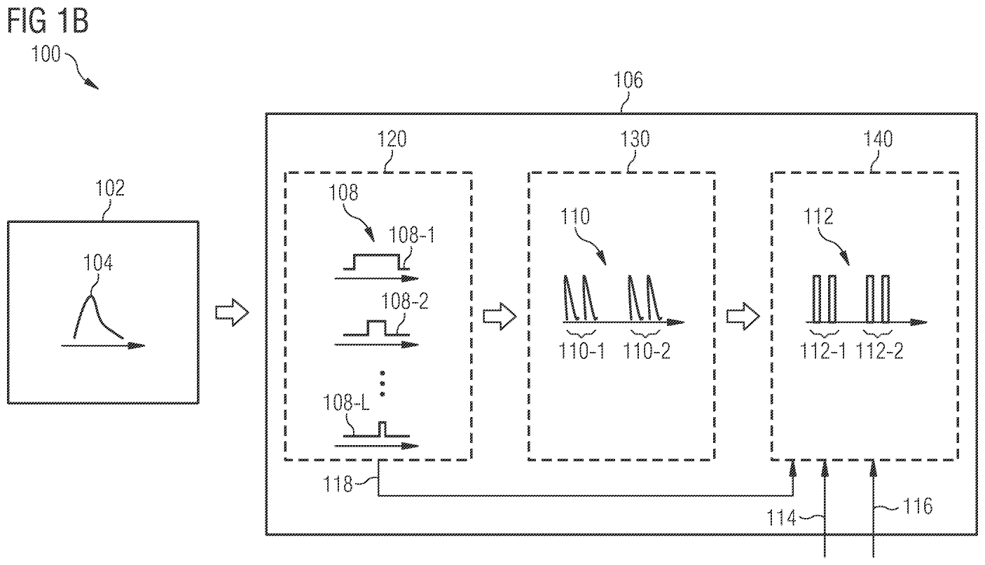

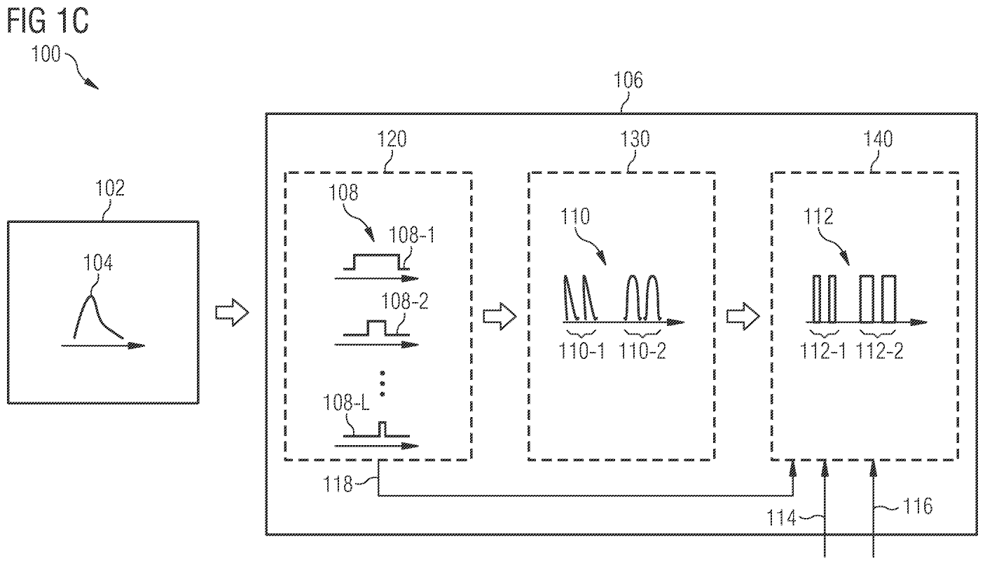

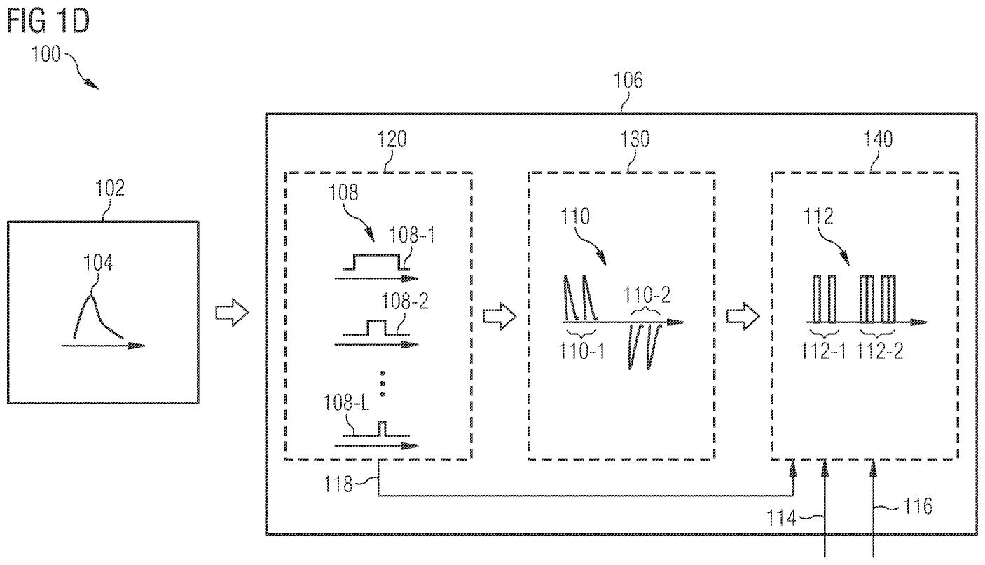

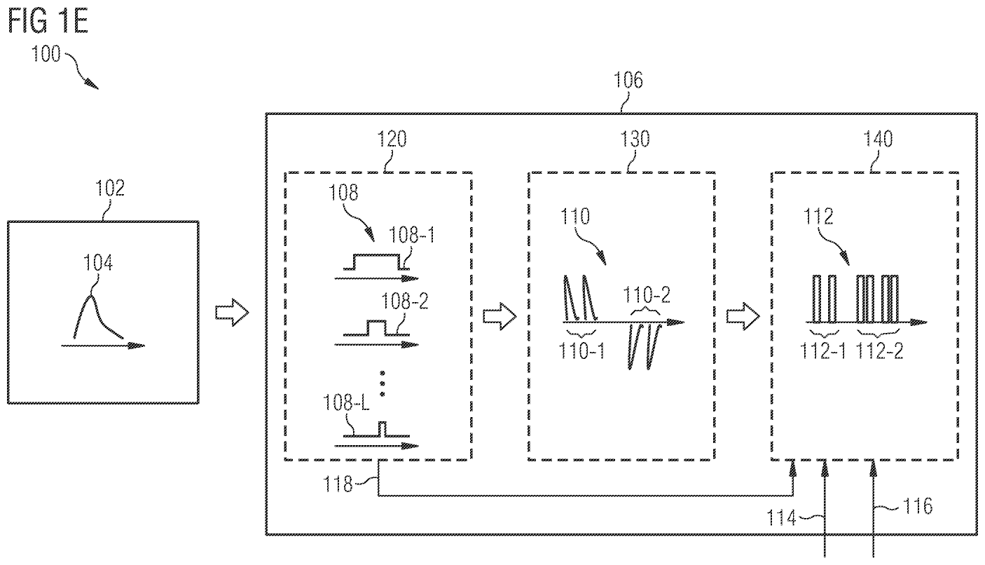

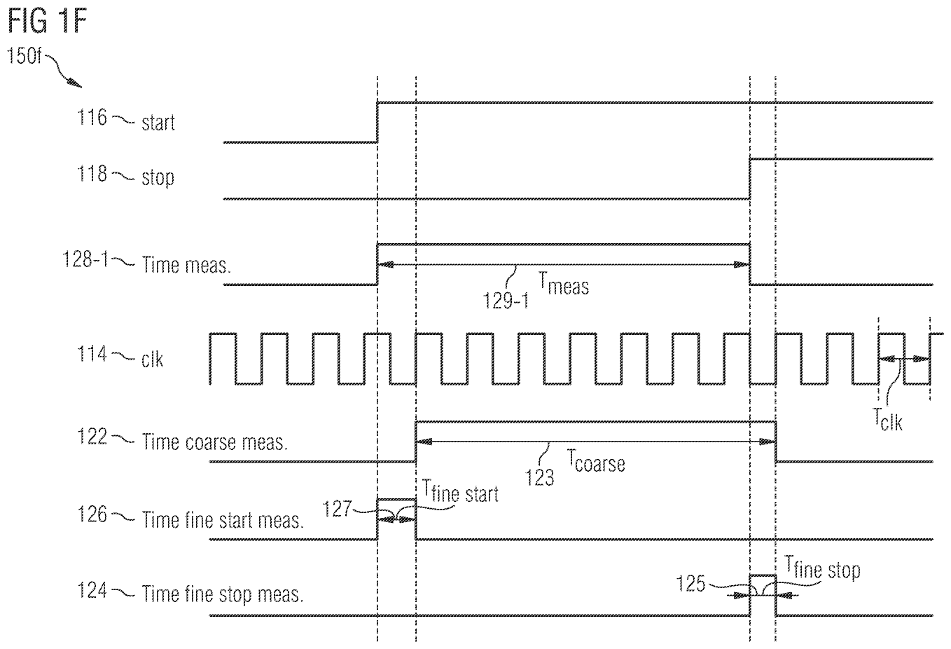

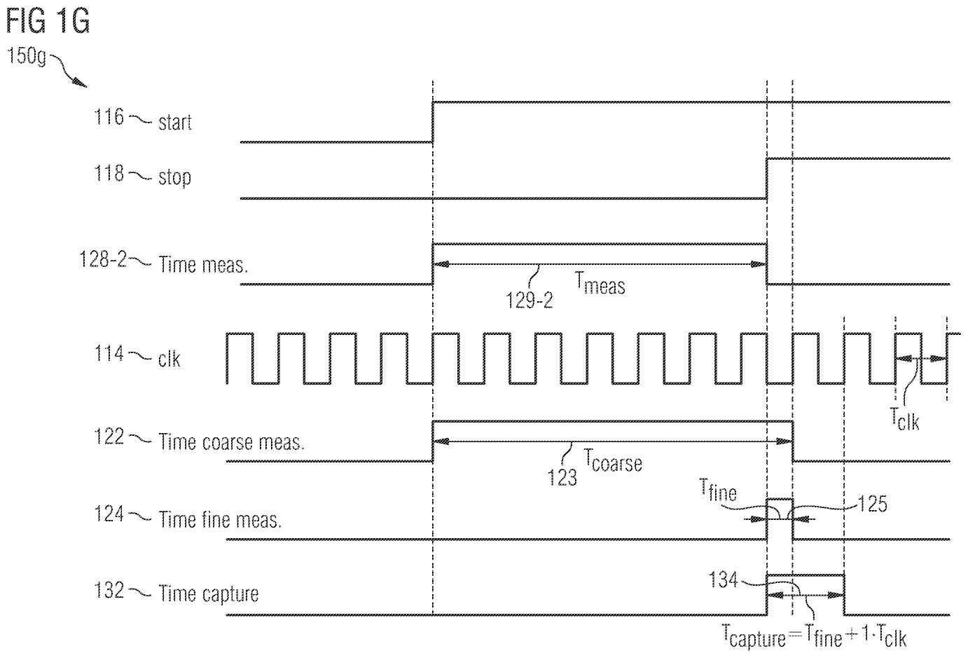

FIG. 1A to FIG. 1E each shows a schematic diagram of a detection system 100 according to various aspects. In some aspects, the detection system 100 may be a light detection system, e.g. in case a signal to be detected (and processed) is or includes a light signal. In some aspects, the detection system 100 may be a light detection system for use in a LIDAR system. In some aspects, a LIDAR system may include one or more detection systems 100.

The detection system 100 may include a detector 102 configured to provide a received signal 104. The detector 102 may be configured to receive a signal, such as a light signal, an ultrasound signal, a RADAR signal, a radiofrequency signal, as examples, and to provide an analog representation of the received signal 104. In some aspects, providing a received signal 104 may be understood as detecting a signal and providing a representation of the detected signal. As an example, the detector 102 may be configured to provide an analog signal (e.g., a current or a voltage) associated with the signal received at the detector 102, e.g. an analog signal representing the signal received at the detector 102. In some aspects, a received signal 104 may be provided as a representation that may be processed by a processing circuit 106, as described in further detail below. The signal received at the detector 104 may be itself an analog signal, and may be provided in an analog representation that allows further processing. Illustratively, the received signal 104 may be understood as an analog representation of a (analog) signal received at the detector 102.

The detection system 100 may include a processing circuit 106, configured to process the received signal 104. The detector 102 and the processing circuit 106 may be connected with one another, and the detector 102 may be configured to provide (e.g., transmit or communicate) the received signal 104 to the processing circuit 106.

The processing circuit 106 may be configured to provide (e.g., to generate) a plurality of quantized signals 108 (in some aspects, a sequence of quantized signals 108). In the exemplary representation in FIG. 1, the processing circuit 106 may be configured to provide a first quantized signal 108-1, a second quantized signal 108-2, . . . , and a L-th quantized signal 108-L. Each quantized signal 108 may be associated with a respective threshold level (also referred to herein as reference level), and may be representative of the portions of the received signal 104 in which a signal level of the received signal 104 is greater than the respective threshold level. The quantized representation of the received signal 104 may provide the possibility of encoding the received signal 104 in a way that allows extracting the desired (additional) information, as described in further detail below. A threshold level may include a threshold signal level that may be associated with (e.g., expressed in relation to) a signal amplitude, a signal power, or a signal intensity, for example a threshold level may include at least one of a threshold current or a threshold voltage.

In some aspects, the provision (e.g., the generation) of the plurality of quantized signals 108 may include, for each quantized signal 108, comparing the signal level of the received signal 104 with the respective threshold level. Illustratively, the signal level of the received signal 104 may vary over time, and the comparison may include, for each quantized signal 108, determining over time whether the signal level of the received signal 104 is above or below the associated threshold level. A quantized signal 108 may be or may include a (further) analog signal providing a quantized representation of the signal level of the received signal 104 with respect to the associated threshold level. As an example, a current level or voltage level associated with the received signal 104 may be compared, for each quantized signal 108, with the respective threshold current or threshold voltage.

A quantized signal 108 may include a quantized representation of whether (and where) the signal level of the received signal 104 is above or below the respective threshold level. A quantized signal 108 may include (illustratively, may assume) a first value (e.g., a high value corresponding to a logical “1”) associated with the portions of the received signal 104 in which the signal level is greater than the respective threshold level, and a second value (e.g., a low value corresponding to a logical “0”) associated with the portions of the received signal 104 in which the signal level is less than the respective threshold level. Illustratively, a quantized signal 108 may be at a first (e.g., high) level in correspondence of the portions of the received signal 104 in which the signal level of the received signal 104 is greater than the respective threshold level, and may be at a second (e.g., low) level in correspondence of the portions of the received signal 104 in which the signal level of the received signal 104 is less than the respective threshold level. It is understood that the definition of high level, low level, high value, and low value for a quantized signal 108 may be selected arbitrarily.

20 In the exemplary representation in FIG. 1, the first quantized signal 108-1 may be associated with a first threshold level, the second quantized signal 108-2 may be associated with a second threshold level, and the L-th quantized signal 108-L may be associated with a L-th threshold level. Each quantized signal 108-1, 108-2, 108-L may include (assume) a respective low value and a respective high value in accordance with the behavior of the received signal 104 in relation to the respective threshold level. In the exemplary configuration in FIG. 1A to FIG. 1E, the second threshold level may be greater than the first threshold level, so that the second quantized signal 108-2 is at a high level for a shorter period of time compared to the first quantized signal 108-1 (illustratively, the second quantized signal 108-2 switches from the low value to the high value at a later time point compared to the first quantized signal 108-1, and switches from the high value to the low value at an earlier time point compared to the first quantized signal 108-1). The L-th threshold level may be greater than the second threshold level, so that the L-th quantized signal 108-L is at a high level for a shorter period of time compared to the second quantized signal 108-2 (and compared to the first quantized signal 108-1).

The processing circuit 106 may be configured to provide (e.g., to generate) an encoded signal 110 based on the plurality of quantized signals 108. The encoded signal 110 may include signal values (encoded signal values) representing the behavior of the received signal 104 over time. The encoded signal values may illustratively represent where the signal level of the received signal 104 is increasing (e.g., from being greater than a threshold level to being greater than a higher threshold level) or decreasing (e.g., from being less than a threshold level to being less than a smaller threshold level). Providing the encoded signal 110 allows representing the received signal 104 in a way that allows extracting the desired information, as described in further detail below.

The encoded signal 110 may include a first plurality (e.g., a 20 first sequence) of first encoded signal values 110-1 being representative of the portions of the received signal 104 in which the signal level of the received signal 104 becomes greater than one of the threshold levels associated with the quantized signals 108. The encoded signal 110 may include a second plurality (e.g., a second sequence) of second encoded signal values 110-2 being representative of the portions of the received signal 104 in which the signal level of the received signal 104 becomes less than (in other words, smaller than) one of the threshold levels associated with the quantized signals 108. Illustratively, the first encoded signal values 110-1 may be representative of the portions of the received signal 104 in which a slope of a tangent to the received signal 104 is positive, and the second plurality of second encoded signal values 110-2 may be representative of the portions of the received signal 104 in which the slope of the tangent to the received signal 104 is negative.

The provision (e.g., the generation) of the encoded signal 110 based on the plurality of quantized signals 108 may include determining the location(s) in the received signal 104 where the signal level increases in a way that a quantized signal 108 goes to a high level (to determine the first encoded signal values 110-1), or decreases in a way that a quantized signal 108 goes to a low level (to determine the second encoded signal values 110-2).

The processing circuit 106 may be configured to perform (in other words, to carry out) a time-to-digital conversion of the encoded signal 110 to provide a digitized signal 112 (in other words, a digital signal 112). The digitized signal 112 may include a first plurality of first digitized values 112-1 associated with the first encoded signal values 110-1. Illustratively, the processing circuit 106 may be configured to provide the first digitized values 112-1 by time-to-digitally converting the first encoded signal values 110-1. The digitized signal 112 may include a second plurality of second digitized values 112-2 associated with the second encoded signal values 110-2. Illustratively, the processing circuit 106 may be configured to provide the second digitized values 112-2 by time-to-digitally converting the second encoded signal values 110-2. The digitized signal 112 may be provided (for further processing) as a single signal (on single output, see FIG. 1B to FIG. 1E) or as two separate signals (two separate outputs, see FIG. 1A).

The time-to-digital conversion of the encoded signal no may include generating a digitized value in correspondence of each encoded signal value. The digitized signal 112 may be understood as a sequence of digitized values providing a digitized representation of the time-evolution of the encoded signal no (and thus of the received signal 104). The time-to-digital conversion may include providing a digitized value of a first type (e.g., a logic “1”) in correspondence of the portions of the encoded signal no in which an encoded signal value is present, and providing a digitized value of a second type (e.g., a logic “0”) in correspondence of the portions of the encoded signal no in which an encoded signal value is absent, as described in further detail below.

The digitized signal 112 provided as described herein allows reconstructing the shape of the received signal 104 and allows determining amplitude information of the received signal 104. Illustratively, the information that the digitized signal 112 represents (e.g., digitally encodes) in light of the way in which it was generated provides the possibility of amplitude and/or shape reconstruction. The provision of quantized signals 108 ensures that information about the signal level of the received signal 104 is included in the digitized signal 112, and the provision of the encoded signal 110 ensures that information about the variation over time (and the steepness of the variation) of the signal level of the received signal 104 is included in the digitized signal 112.

FIG. 1A to FIG. 1E show in a schematic manner various possibilities for providing the encoded signal 110 and/or the digitized signal 112.

In the exemplary configuration in FIG. 1A, the first encoded signal values 110-1 may differ from the second encoded signal values 110-2 in terms of polarity, e.g. the first encoded signal values 110-1 associated with the positive slope of the received signal 104 may have a positive polarity, and the second encoded signal values 110-2 associated with the negative slope of the received signal 104 may have a negative polarity.

In the exemplary configuration in FIG. 1B, the first encoded signal values 110-1 may have a same polarity as the second encoded signal values 110-2, and the distinction between the first encoded signal values 110-1 and the second encoded signal values 110-2 may be operated by separating the first encoded signal values 110-1 from the second encoded signal values 110-2 in time.

In the exemplary configuration in FIG. 1C, the first encoded signal values 110-1 may differ from the second encoded signal values 110-2 in terms of pulse width, e.g. the first encoded signal values 110-1 may be associated with first pulses (e.g., current or voltage pulses) having a first width, and the second encoded signal values 110-2 may be associated with second pulses having a second width. In the exemplary configuration in FIG. 1C the second pulses may be broader than the first pulses, it is however understood that the choice of which pulses are broader is arbitrary. This may lead to the digitized signal 112 having digitized signal values 112-1, 112-2 that differ from one another in terms of width, in accordance with the difference between the first encoded signal values 110-1 and the second encoded signal values 110-2.

In the exemplary configuration in FIG. 1D and FIG. 1E, digital encoding is shown, in which the first encoded signal values 110-1 and the encoded signal values 110-2 are digitally encoded onto different sequences of digital values. Each first encoded signal value 110-1 is encoded onto a respective (same) first sequence of digitized values, and each second encoded signal value 110-2 is encoded onto a respective (same) second sequence of digitized values. In the exemplary configuration in FIG. 1D, only as an example, a first digitized value 112-1 associated with a first encoded value 110-1 may include the first sequence of digitized values, e.g. a “10” pulse, and a second digitized value 112-2 associated with a second encoded value 110-2 may include the second sequence of digitized values, e.g. a “11” pulse. In the exemplary configuration in FIG. 1E, only as another example, a first digitized value 112-1 associated with a first encoded value 110-1 may include the first sequence of digitized values, e.g. a “100” pulse, and a second digitized value 112-2 associated with a second encoded value 110-2 may include the second sequence of digitized values, e.g. a “101” pulse. It is understood that the choice of the sequence to be assigned to the first or second encoded signal values 110-1, 110-2 is arbitrary.

In some aspects, the processing circuit 106 may be configured to determine (e.g., calculate or estimate) amplitude information associated with the received signal 104 by using the digitized signal 112 and/or to determine a shape of the received signal 104 by using the digitized signal 112, as discussed in further detail below. In some aspects, the processing circuit 106 may be configured to reconstruct the shape of the received signal 104 by using the digitized signal 112. For example, the processing circuit 106 may be configured to reconstruct the shape of the received signal 104 by comparing the digitized signal 112 to a plurality of known digitized signals. The processing circuit 106 may reconstruct the shape of the receive signal in accordance with the result of the comparison, e.g. based on which known digitized signal is more similar to the determined digitized signal 112 (e.g., which known digitized signal has more features in common with the determined digitized signal 112).

The adapted TDC-approach inherently provides timing information about the start and also the end of a captured pulse (as described in further detail below). This provides the possibility of adopting binary correlation receiver concepts (e.g., the processing circuit 106 may include one or more correlation receivers configured to process the received signal 104). A binary correlation receiver may operate, for example, with the digitized signal 112, to provide a correlation output that may be used to determine various properties of the received signal 104, as described in further detail below.

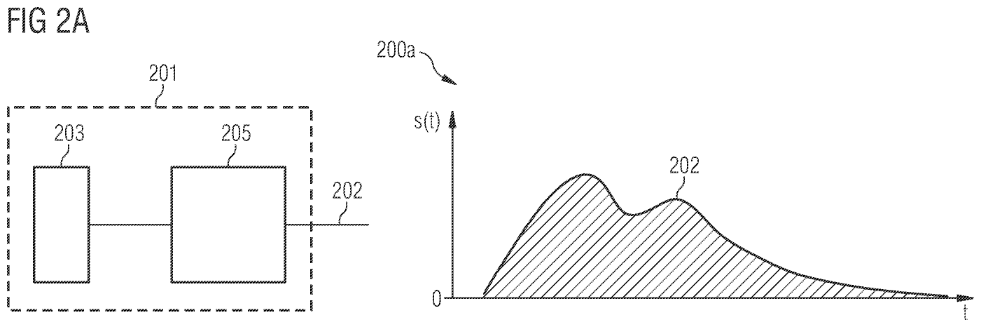

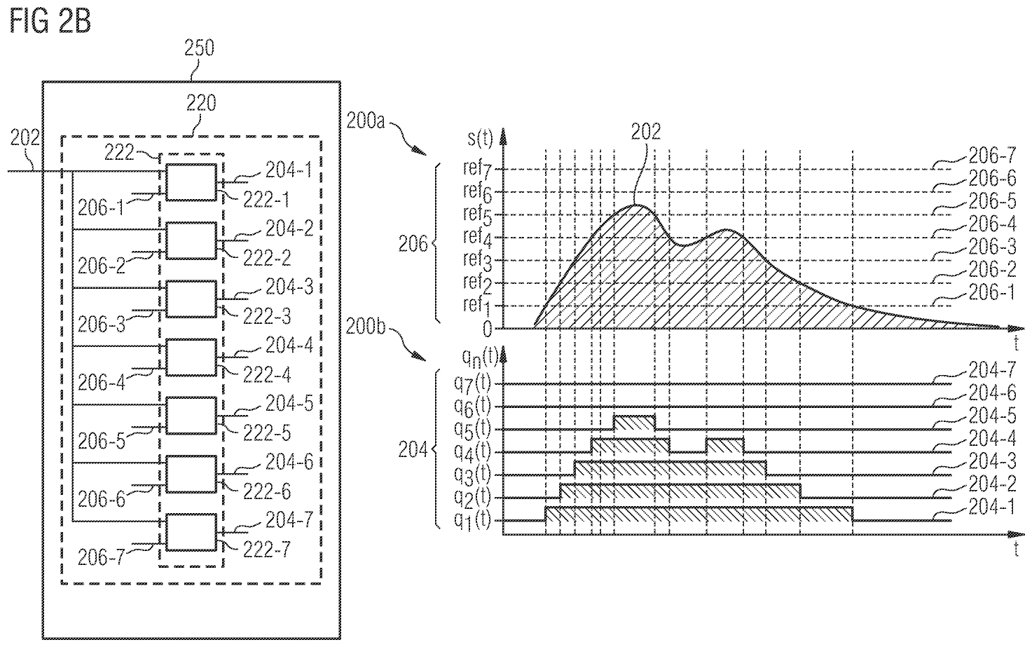

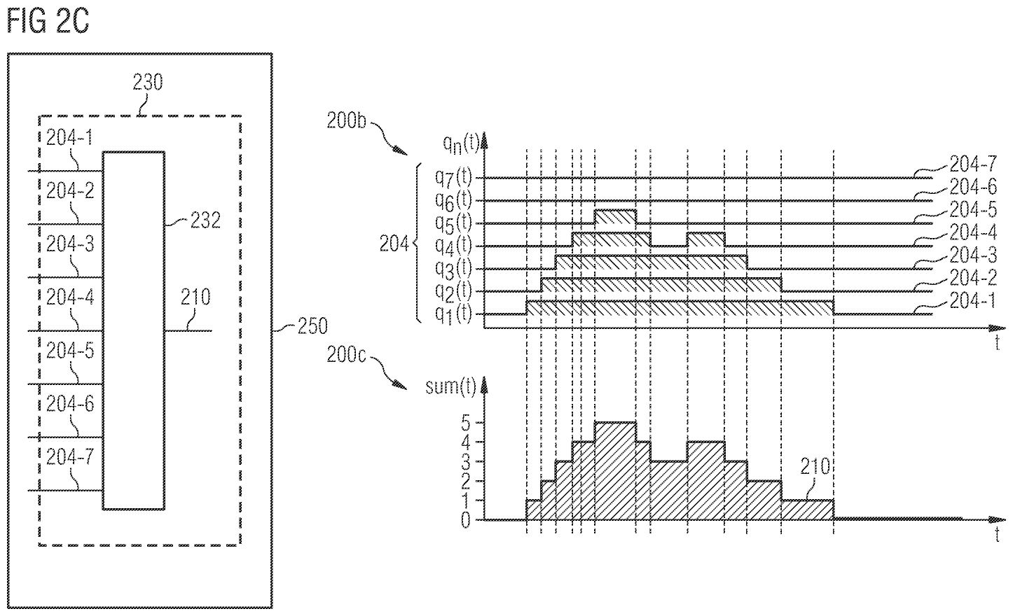

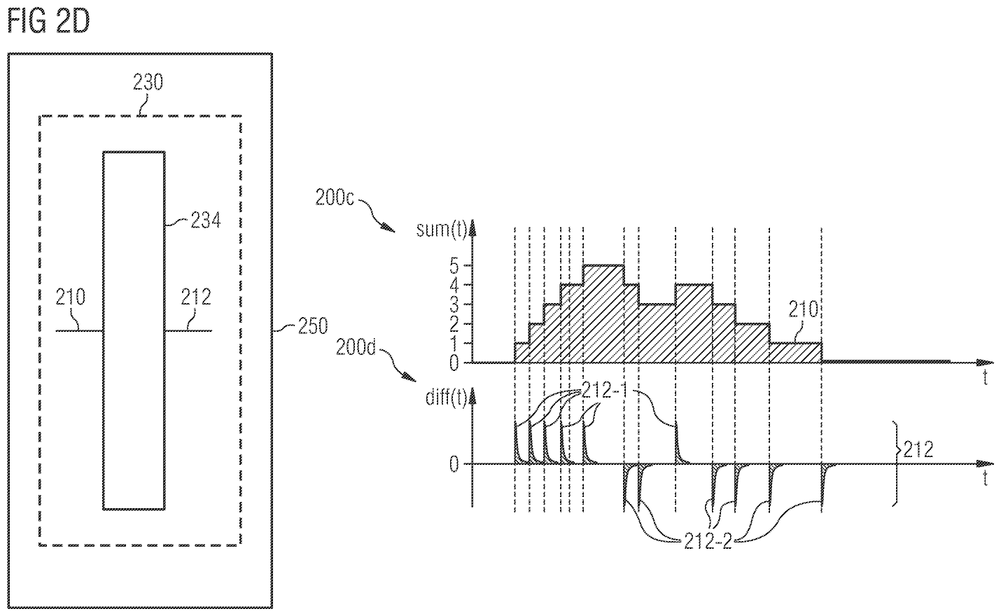

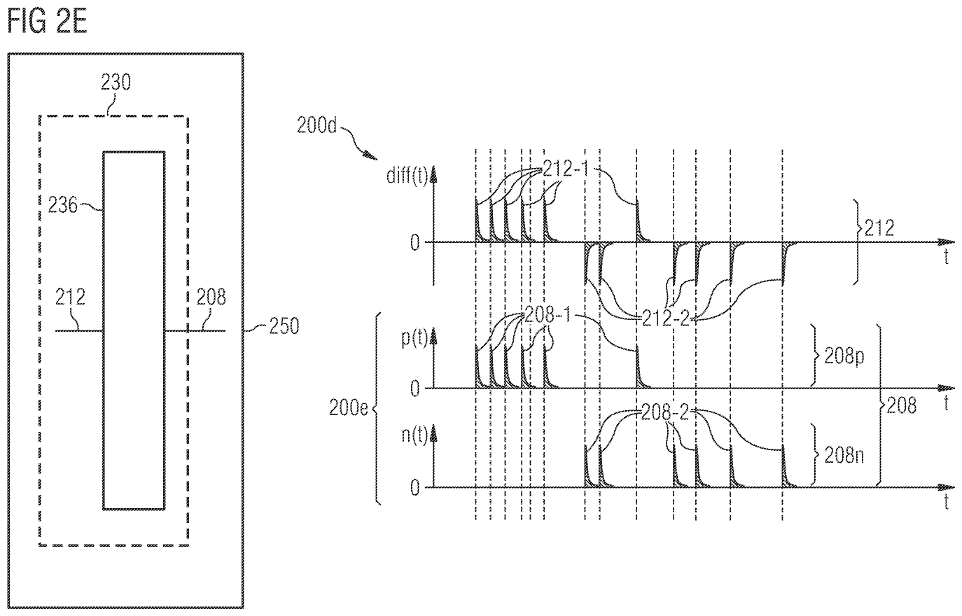

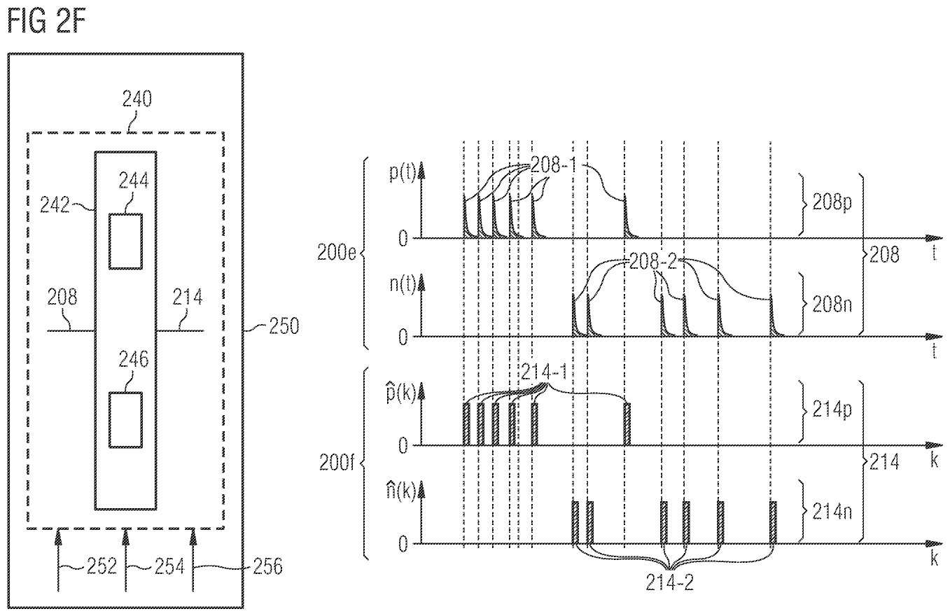

More advanced non-binary correlation receiver concepts, for example, concepts based on correlation receivers that operate on discretized multi-level signals (e.g., like the cumulated summation signal described below in relation to FIG. 2F), may be adopted since the shape of the emitted pulse is either known or it can be measured. Also, the shape of the detected pulse is inherently captured, which allows to include the pulse shape into the calculation of the cross-correlation, thus improving decoding performance.

A (e.g., each) correlation receiver may be associated with at least one reference signal sequence (e.g., with a respective one of one or more reference signal sequences). A reference signal sequence may be representative of a (e.g., known or predefined) sequence of captured and digitized signal values. A (e.g., each) each correlation receiver may be configured to correlate at least one of the digitized signal 112 and/or the cumulated summation signal (described in further detail below, e.g. in relation to FIG. 2F) with the (respective) reference signal sequence to provide a (respective) correlation output (e.g., a respective one of one or more correlation outputs). Illustratively, each correlation receiver may be configured to correlate a captured signal with the (respective) reference signal sequence to provide a (respective) correlation output. The captured signal may include at least one of the digitized signal 112 and/or the cumulated summation signal. A correlation of the captured signal with a reference signal sequence may be carried out as commonly known in the art.

The processing circuit 106 may be configured to (jointly) use the one or more correlation outputs (provided by the one or more correlation receivers) to compare the captured signal with (each of) the one or more reference signal sequences. The processing circuit 106 may be configured to determine which reference signal sequence is most representative of the captured signal based on the correlation outputs. Illustratively, each correlation output may be representative of a matching between the captured signal and the respective reference signal sequence (e.g., a high value of the correlation output may indicate a high degree of matching, and a low value of the correlation output may indicate a low degree of matching). The processing circuit 106 may be configured to determine the reference signal sequence that is most representative of the captured signal based on which reference signal sequence has the greatest correlation output associated therewith. Such reference signal sequence may be referred to herein as selected reference signal sequence.

The processing circuit 106 may be configured to carry out processing of the received signal 104 based on (in other words, in accordance with) the result on the comparison, illustratively, based on the correlation between the captured signal and the one or more reference signal sequences. As an example, the processing circuit 106 may be configured, based on the result of the comparison, to determine amplitude information associated with the received signal 104 (e.g., based on known amplitude information of the selected reference signal sequence). As another example, the processing circuit 106 may be configured, based on the result of the comparison, to reconstruct the shape of the received signal 104 (e.g., based on known shape information of the selected reference signal sequence). As a further example, the processing circuit 106 may be configured, based on the result of the comparison, to determine a time-of-flight associated with the received signal 104.

For the purpose of explanation, the processing circuit 106 may include (may be divided into) a quantization stage 120, an encoding stage 130 (also referred to herein as analog encoding stage), and a digitalization stage 140 (in some aspects further configured to perform digital encoding) to carry out the processing of the received signal 104. It is however understood that the various functions described herein are not necessarily performed in separate stages, or in stages separated as exemplarily illustrated herein. Illustratively, the functions described herein in relation to a “stage” of a processing circuit may be understood to be carried out by the processing circuit.

In some aspects, the processing circuit 106 may be configured to determine a time-of-flight associated with the received signal 104. The time-of-flight associated with the received signal 104 may describe a time elapsed from the emission of the signal and the reception of the signal (e.g., at the detector 102). As an example, the received signal may include a light signal, and the time-of-flight associated with the received light signal may be used to determine a distance to an object that reflected the light signal. As another example, the received signal may include an ultrasonic signal, and the time-of-flight associated with the received light signal may be used to determine a distance to an object that reflected the ultrasonic signal. A time-of-flight measurement based on a TDC-approach may in general be known in the art, a brief description will be provided herein to discuss the aspects relevant for the adapted TDC-approach. The determination of time-of-flight will be described in further detail with reference to FIG. 1F and FIG. 1G.

The processing circuit 106 (e.g., the digitalization stage 140) may be configured to receive a clock signal 114 and to determine the time-of-flight associated with the received signal 104 in accordance with the clock signal 114. The clock signal 114 may be or include a clock signal as commonly understood in the art (e.g., produced by a clock generator), oscillating between a high state and a low state and being used to coordinate the functions of the processing circuit 106.

The processing circuit 106 (e.g., the digitalization stage 140) may be configured to receive a start signal 116 indicative of a start of an emission of the received signal 104, and to determine the time-of-flight associated with the received signal 104 in accordance with the start signal 116. The start signal 116 may be provided, for example, by an emission system emitting the signal 104 (e.g., by a light emission system emitting a light signal). The start signal 116 may be used as a starting point for starting the measurement of the time-of-flight (see also FIG. 1F and FIG. 1G).

In some aspects, the processing circuit 106 (e.g., the quantization stage 120) may be configured to provide (e.g., to generate) a stop signal 118 upon reception of the received signal 104. Illustratively, the stop signal 118 may be used to represent that the (emitted) signal has been received at the detector 102, so that the time-of-flight measurement may be stopped. In some aspects, the processing circuit 106 may be configured to provide the stop signal 118 upon the quantized signal 108 associated with the smallest threshold value turning to the high level. Such quantized signal (e.g., the first quantized signal 108-1 in the exemplary scenario in FIG. 1A to FIG. 1E) may be used as stop signal 118. Illustratively, the quantized signal 108 associated with the smallest threshold value turning high may indicate that a signal (e.g., different from a noise level) has been received. The processing circuit 106 (e.g., the digitalization stage) may be configured to determine the time-of-flight associated with the received signal 104 in accordance with the stop signal 118.

In general, a time-to-digital converter (e.g., the processing circuit 106) may be understood as an electronic system that measures the time duration between two occurring events of a given signal. A time-to-digital converter may be configured to convert temporal information into a digital format suitable for data processing. The time-to-digital converter should ideally cover a large temporal rage with a good precision and accuracy. However, the implementation should not be too complex in order to stay tractable. Therefore, in some aspects, the time duration measurement may be done not in a single stage but may be split into two or even more stages.

The processing circuit 106 (e.g., the digitalization stage 140) may include one or more time-to-digital conversion stages configured to provide the measurement of the time-of-flight associated with the received signal 104. In some aspects, the processing circuit 106 may include at least a coarse time-to-digital conversion stage (also referred to herein as coarse stage) configured to provide a coarse measurement of the time-of-flight associated with the received signal 104, and a fine time-to-digital conversion stage (also referred to herein as fine stage) configured to provide a fine measurement of the time-of-flight associated with the received signal 104. The coarse stage and the fine stage may work together to achieve a long range and good precision. This configuration will be described in further detail with reference to FIG. 1F and FIG. 1G.

FIG. 1F and FIG. 1G show a respective timing diagram 150f, 150g illustrating time measurement according to a time-to-digital conversion approach. The timing diagrams 150f, 150g are described with particular reference to the case in which the measured time is a time-of-flight associated with a signal, it is however understood that the measured time may also describe different types of events or properties.

The coarse time-to-digital conversion stage may be configured to provide a coarse time measurement signal 122 based on an integer number of clock cycles of the clock signal 114. The coarse time measurement signal 122 may provide a coarse time measurement duration 123 (Tcoarse), e.g. the duration for which the coarse time measurement signal 122 is at a high level. The coarse time measurement may include an integer number of clock cycles between the start signal 116 and the stop signal 118. Illustratively, the coarse stage may be configured to perform the measurement by counting the number of clock periods between two events in time (that are generally not synchronized with the clock).

The fine time-to-digital conversion stage may be configured to provide a (first) fine time measurement signal 124 based on the stop signal 118 and a reference point of the clock signal 114. The first fine time measurement signal 124 may provide a first fine time measurement duration 125 (T_{fine_stop}), e.g. the duration for which the first fine time measurement signal is at a high level. As an example, the reference point of the clock signal 114 may include a positive edge or a negative edge of the clock cycle subsequent to the stop signal 118. It is however understood that any suitable reference point may be used for determining the fine time measurement signal 124 and fine time measurement duration 125.

In some aspects, the fine time-to-digital conversion stage may optionally be configured to provide a (second) fine time measurement signal 126 based on the start signal 116 and a reference point of the clock signal 114 (e.g., a positive edge or a negative edge of the clock cycle subsequent to the start signal 116), see FIG. 1F. This may be the case, for example, if the emission of the signal is not synchronized with the clock signal 114, as described in further detail below. The second fine time measurement signal 126 may provide a second fine time measurement duration 127 (T_{fine_start}), e.g. the duration for which the second fine time measurement signal 126 is at a high level

The processing circuit 106 may be configured to determine the time-of-flight 129-2 (a second time-of-flight duration 129-2, associated with a second time-of-flight measurement signal 128-2) associated with the received signal 104 based on the coarse time measurement signal 122 and the (first) fine time measurement signal 124 (see FIG. 1G). As an example, the processing circuit 106 may be configured to determine the time-20 of-flight 129-2 as a difference between the coarse time measurement signal 122 and the (first) fine time measurement signal 124 (a difference between the coarse time measurement duration 123 and the first fine time measurement duration 125). Optionally (see FIG. 1F), the processing circuit 106 may be configured to determine the time-of-flight 129-1 associated with the received signal 104 based on the coarse time measurement signal 122, the first fine time measurement signal 124 and the second fine time measurement signal 126, e.g. by adding the coarse time measurement duration 123 and the second fine time measurement duration 127, and subtracting the first fine time measurement duration 125.

The timing diagram 150f in FIG. 1F refers to the scenario in which the time measurement is carried in three steps: two fine measurement steps and a single coarse measurement step. The fine stage may be configured to determine the sub-clock cycle differences between the event and the clock cycles themselves on both sides (illustratively, at the beginning and the end of the coarse measurement) that cannot be resolved by the coarse stage since their duration is shorter than the clock period.

As illustrated in the timing diagram 150, the time interval to be measured 129-1 (Tₘₑₐₛ) (a first time-of-flight duration 129-1 associated with a first time-of-flight signal 128-1) is a combination of three individual durations:
a) T_{coarse} 123, which is the measured time duration of the coarse measurement (obtained by counting number N_{coarse} of clock periods T_{clk} from enabling to disabling of the coarse measurement);
b) T_{fine_start} 127, which is the time between the start event defined, for example, by the active edge of the start signal 116 and the first following rising clock edge; and
c) T_{fine_stop} 125, which is the time between the stop event defined, for example, by the active edge of the stop signal
118 and the following rising clock edge.

Accordingly, the measured time Tₘₑₐₛ 129-1 may be expressed as follows:

Tₘₑₐₛ=T_{fine_start}+T_{coarse}−T_{fine_stop} (1)

where,

T_{coarse}=N_{coarse}·T_{clk} and thus, (2)

TₘₑₐₛT_{fine_start}+N_{coarse}−T_{clk}−T_{fine_stop} (3)

In some aspects, the start event may be synchronized with the clock signal 114. Therefore, the measurement of T_{fine_start} 127 may be dispensed with, and Tₘₑₐₛ 129-2 (see the timing diagram 150g in FIG. 1G) may be determined by the measurement of T_{coarse} 123 and Tfine_stop 125. In the remainder of this description it may be assumed that the start event (the emission of the signal) is synchronized with the clock signal 114, and T_{fine_stop} 125 may be denoted as T_{fine}. Using this notation Tₘₑₐₛ 129-2 may be expressed as,

Tₘₑₐₛ=N_{coarse}·T_{clk}−T_{fine}

In some aspects, the processing circuit 106 may be configured not only to measure the time duration between two events but also to adapt the measurement to capture the detected signal 104. Illustratively, the processing circuit 106 may be 10 configured not to stop the measurement upon issuing the stop signal 118, but to continue the signal detection for a predefined time after the generation of the stop signal 118 to ensure that the signal received at the detector 102 is fully detected. The processing circuit 106 may be configured to continue capturing the received signal 104 for a predefined time period 134 (associated with a time capture signal 132) after the stop signal 118 (illustratively, after having generated the stop signal 118), see FIG. 1G. The predefined time period 134 may include the (first) fine time measurement duration 125 and a predefined number of clock cycles of the clock signal 114. As an example, the predefined time period 134 may be a sum of the fine time measurement duration 125 and a predefined (integer) number of clock cycles of the clock signal 114.

The detected signal 104 may include one or more pulses that may vary in shape and/or duration. A maximum duration of the detected signal to be captured may be defined as T_{signal_max}. In order to fully capture the detected signal 104, and assuming that the fine stage may also be used for capturing the detected signal 104, as described in further detail below, it may be determined that T_{fine} may be prolonged by a (predefined) time that is at least as long as T_{signal_max}. In principle, this prolongation time 134 (illustratively, the predefined time period) may be chosen arbitrarily. As an example, taking into consideration the implementation, the predefined time period 134 may be defined based on the clock cycle, e.g. as a multiple of clock cycles (while ensuring that it is longer than T_{signal_max}). The prolonged time period 134 including T_{fine} 125 may be denoted as the capture time T_{capture}. In the exemplary configuration shown in FIG. 1G, the capture time 134 may be defined as T_{fine} 125 prolonged by one clock period T_{clk}

In some aspects, the extension of the detection time by T_{capture} 134 may provide multi-hit detection capabilities, e.g. in case the received signal 104 includes a plurality of pulses (e.g., a plurality of light pulses). The capture time T_{capture} 134 may be extended such that a longer time duration following an initial pulse in the detected signal 104 can be monitored. The processing circuit 106 may be configured to analyze the captured sequence for additional pulses following the initial pulse and determine the corresponding time shifts as well as other desired parameters like amplitude and pulse shape information. This approach may be suitable for pulses that occur in short temporal succession, and may provide fast and accurate detection.

The functions of a processing circuit (e.g., of the processing circuit 106) will be described in further detail with reference to FIG. 2A to FIG. 2F that show various aspects of the processing of a signal (e.g., of the received signal 104).

FIG. 2A shows a detector 201 and a graph 200a associated with a signal 202 according to various aspects. The detector 201 may be an exemplary implementation of the detector 102, and the signal 202 may be an example of a received signal (e.g., of the received signal 104, described in relation to FIG. 1A to FIG. 1E). The graph 200a may illustrate an exemplary signal 202 received or detected (e.g., at a detection system 100) and which may be processed by a processing circuit, e.g. by the processing circuit 106 described in relation to FIG. 1A to FIG. 1E. In some aspects, the signal 202 may be an example of a LIDAR detected signal, e.g. including one or more emitted light pulses to which noise (and/or light from other sources) may be superimposed. The graph 200a may show the signal 202 (s(t), in the vertical axis) over time (t, in the horizontal axis). The representation in FIG. 2A may be in terms of any suitable parameter associated with the signal (e.g., with its signal level), such as a power, current, amplitude, or voltage.

The detector 201 may be configured to receive a signal (e.g., a light signal, a RADAR signal, an ultrasound signal, a radiofrequency signal etc.) and provide a received signal 202 representing the signal received at the detector 201.

The detector 201 may include a sensing element 203 (or a plurality of sensing elements) sensitive for the signal to be detected. The sensing element 203 may be configured to generate a response signal upon a signal impinging onto the sensing element 203. The response signal may include a (first) analog signal of a first type, e.g., a current. The response signal may be proportional to the signal sensed by the sensing element 203 (and may follow the behavior of the sensed signal).

In some aspects, the detector 201 may include a plurality of sensing elements 203 (e.g., of the same type or of different types). In this configuration, the plurality of sensing elements 203 may form an array, e.g. a one-dimensional or two-dimensional array. Illustratively, the sensing elements 203 may be disposed along one direction (e.g., a vertical direction or a horizontal direction), or may disposed along two directions, e.g. a first (e.g., horizontal) direction and a second (e.g., vertical) direction.

In some aspects, the detector 201 (e.g., the sensing element 203) may include at least one photo diode, e.g. in case the signal to be detected is or includes a light signal. The detector may be understood in this case as a photo detector that detects an optical signal and converts it into an analog signal (e.g., into an electrical current signal). The at least one photo diode may be configured to generate an analog signal (e.g., a photo current) in response to a light signal impinging onto the at least one photo diode. As examples, the photo diode may include at least one of a PIN photo diode, an avalanche photo diode (APD), a single photo avalanche diode, or a silicon photomultiplier. It is understood that the sensing element 203 may be adapted (e.g., selected) based on the type of signal to be detected, and, instead of or in addition to a photo diode, may be or include a radar receiver (e.g., including an antenna), an ultrasonic transducer, etc.

The detector 201 may include at least one amplifier circuit 205 configured to amplify the response signal generated by the sensing element 203 (e.g., the response signal generated by the at least one photo diode). The amplifier circuit 205 may be coupled with the sensing element 203, and may be configured to receive the (first) analog signal provided by the sensing element, and may be configured to amplify the received analog signal. The amplifier circuit 205 may be configured to provide a (second) analog signal by amplifying the received (first) analog signal.

In some aspects, the amplifier circuit 205 may be configured to change a type of the received analog signal, e.g. from a current to a voltage or vice versa. Illustratively, the amplifier circuit 205 may be configured to provide a second analog signal of a second type based on the received first analog signal of a first type. The amplifier circuit 205 may include at least one of a current amplifier, a voltage amplifier, or a power amplifier. As examples, the amplifier circuit 205 may include at least one of a logarithmic amplifier, a transimpedance amplifier, or a logarithmic transimpedance amplifier. Considering, for example, the case in which the sensing element 203 includes one or more photo diodes (e.g., PIN or APD) the input signal to the amplifier circuit 205 may be a current signal, and the amplifier circuit 205 may include a transimpedance amplifier (TIA) to amplify and convert the signal into a voltage signal. Logarithmic amplifiers may be provided in case the received signal amplitude covers a large dynamic range.

A representation in logarithmic scale may provide a very fine resolution.

The sensing element 203 and the amplifier circuit 205 may provide a received signal 202 (denoted as s(t)) at an output of the detector 201 (e.g., at an output coupled with a processing circuit, e.g. with the processing circuit 106, with the processing circuit 250 described below), illustratively an analog (and amplified) representation of a signal sensed by the sensing element 203.

In FIG. 2B to FIG. 2F various components of a processing circuit 250 are described. The processing circuit 250 (and its components) may be an exemplary implementation of the processing circuit 106 described in relation to FIG. 1A to FIG. 1E.

FIG. 2B shows a quantization stage 220 and a quantization of a signal 202 according to various aspects. The graphs 200a and 200b in FIG. 2B may illustrate the provision of a plurality of quantized signals 204 (qn(t)) associated with the received signal 202. The plurality of quantized signals 204 may be an example of the plurality of quantized signals 108 described in relation to FIG. 1A to FIG. 1E. The quantization stage 220 may be a component of a processing circuit (e.g., of the processing circuit 106, 250). Illustratively, the quantization stage 220 may be an example of the quantization stage 120 described in relation to FIG. 1A to FIG. 1E.

The processing circuit 250 (e.g., the quantization stage 220) may be configured to compare the signal level of the received signal 202 with a plurality of threshold levels 206 to provide the plurality of quantized signals 204. Illustratively, the processing circuit 250 may be configured to compare the signal level of the received signal 202 with each threshold level associated with the quantized signals 204. The threshold levels 206 may be adapted in accordance with a desired resolution of the reconstruction of the signal information, e.g. a number of threshold levels 206 and/or a distance between consecutive threshold levels 206 may be selected to provide a desired resolution for the quantization.

In some aspects, the processing circuit 250 (e.g., the quantization stage 220) may include a plurality of comparators 222 (e.g., a comparator array) each associated with a respective reference value 206. A comparator (e.g., each comparator) may be configured to receive, as an input, the received signal 202, and to compare the received signal 202 with the respective reference value 206. A reference value 206 associated with a comparator may correspond to or be associated with a corresponding threshold level 206. A reference value 206 may include a signal value that may be associated with (e.g., expressed in relation to) a signal amplitude, a signal power, or a signal intensity, for example a reference value 206 may include at least one of a current value or a voltage value. Byway of example, the plurality of comparators 222 may include at least one high-gain differential amplifier (e.g., one, or more than one, or each comparator may be or include a high-gain differential amplifier), e.g. a fast discrete component as known in the art. In some aspects, the comparators 222 may be connected in parallel with one another. The received signal 202 may be distributed to each comparator 222, and the plurality of comparators 222 may provide a plurality of parallel output signals, as described in further detail below. Illustratively, the quantization stage 220 may include an array with a number of L comparators 222 that may be used to quantify the amplitude of the detected signal 202 (s(t)). The L comparators 222 may be essentially in parallel all having the signal s(t) as a common input.

A comparator 222 (e.g., each comparator) may be configured to provide a respective first output signal (e.g., a high signal, such as a high voltage) in case the signal level of the received signal 202 is greater than the respective reference value 206, and to provide a respective second output signal (e.g., a low signal, such as a low voltage) in case the signal level of the received signal 202 is less than the respective reference value 206.

The reference values 206 associated with different comparators 222 may be adapted based on a desired resolution of the quantization and/or based on an expected behaviour of the received signal 202. As an example, reference values 206 associated with different comparators may be linearly spaced from one another. The linear spacing together with a logarithmic input amplifier may result in logarithmically spaced thresholds, which allows to cover input signals with a large dynamic range requiring only a relatively low number of comparators (e.g., less than 10, or less than 5). As another example, reference values 206 associated with different comparators may be logarithmically spaced from one another. It is however understood that other types of spacing may be provided, based on the desired resolution and/or on the expected signal.

Illustratively, the comparators 222 may each have a reference level, e.g. a voltage input, which defines a threshold for switching its output from one state to the other state. The reference level may be chosen individually for all the comparators 222 in the array. By choosing logarithmically spaced comparator thresholds a wide dynamic rage can be covered. Essentially this makes it possible to capture the entire dynamic range of the received signal, which may be significantly large for LIDAR applications, while requiring only a very limited number of comparators.

In the exemplary configuration illustrated in FIG. 2B, the plurality of threshold levels 206 may include first to seventh threshold levels 206-1 (ref1), 206-2 (ref2), 206-3 (ref3), 206-4 (ref4), 206-5 (ref5), 206-6 (ref6), 206-7 (ref7). Illustratively, the plurality of comparators 222 may include seven comparators (e.g., first to seventh comparators 222-1, 222-2, 222-3, 222-4, 222-5, 222-6, 222-7), each associated with a respective reference value of first to seventh reference values 206-1, 206-2, 206-3, 206-4, 206-5, 206-6, 206-7.

In some aspects, a difference between reference values 206 associated with different comparators 222 may be constant for the plurality of comparators 222. For example the second reference value 206-2 may be greater than the first reference value 206-1, the third reference value 206-3 may be greater than the second reference value 206-2, etc. A difference between the third reference value 206-3 and the second reference value 206-2 may be equal to a difference between the second reference value 206-2 and the first reference value 206-1, etc. In other aspects, a difference between reference values 206 associated with different comparators 222 may vary between different pairs of comparators 222. The selection of the reference values may be in accordance with an expected behaviour of the received signal 202.

The plurality of quantized signals 204 may represent the result of the comparison between the received signal 202 and the threshold levels 206. In the exemplary configuration illustrated in FIG. 2B, the plurality of quantized signals 204 may include first to seventh quantized signals 204-1 (q1(t)), 204-2 (q2(t)), 204-3 (q3(t)), 204-4 (q4(t)), 204-5 (q5(t)), 204-6 (q6(t)), 204-7 (q7(t)), each associated with a respective threshold level 206.

In some aspects, the plurality of quantized signals 204 may be a function of the respective output signals of the plurality of comparators 222. A quantized signal may be a function of an output signal of one of the comparators 222, e.g. may have a same behaviour as the output signal of the comparator. The signals q1(t) to q7(t) may be understood as the respective outputs of the comparators 222.

As shown in the graph 200b, the first quantized signal 204-1 may be associated with the first threshold level 206-1, and may be at a high level in correspondence of the portions of the received signal 202 having a signal level greater than the first threshold level 206-1. The second quantized signal 204-2 may be associated with the second threshold level 206-2, and may be at a high level in correspondence of the portions of the received signal 202 having a signal level greater than the second threshold level 206-2. Analogously, the third to seventh quantized signals 204-3, 204-4, 204-5, 204-6, 204-7 may be at a high level in correspondence of the portions of the received signal 202 having a signal level greater than the respective threshold level 206-3, 206-4, 206-5, 206-6, 206-7. Each quantized signal 204 may be at a low level in correspondence of the portions of the received signal 202 having a signal level less than the respective threshold level 206.

The duration for which a quantized signal 204 is at the respective high level depends on the associated threshold level 206. Illustratively, for increasing threshold levels 206, the duration of the time for which the associated quantized signal 204 is at high level decreases.

In some aspects, the processing circuit 250 may be configured to determine the time-of-flight associated with the received signal 202 by using the output signal of at least one comparator 222 of the plurality of comparators 222. Illustratively, the processing circuit 250 may be configured to use the output signal of the at least one comparator 222 as a stop signal for stopping a time-of-flight measurement (e.g., the output of the comparator may be provided as the stop signal 118 described in FIG. 1A to FIG. 1E). As an example, the at least one comparator may be the comparator 222 having the smallest reference value associated therewith among the plurality of comparators 222. Illustratively, the reference value associated with the at least one comparator may be the smallest reference value among the reference values associated with the plurality of comparators. The output of the comparator with the lowest, or possibly even a higher, reference level may be used for providing the stop signal, as the presence of a detected signal 202 indicates that the ToF measurement may be stopped.

In some aspects, the quantization stage 220 may include more advanced edge detectors instead of simple comparators. The edge detectors may be configured to be active on the rising or the falling edge, and may be used for quantifying the received signal 202 (s(t)).

FIG. 2C, FIG. 2D, FIG. 2E illustrate an encoding stage 230 and the provision of an encoded signal 208 (see the graph 200e in FIG. 2E) by using the plurality of quantized signals 204. The encoded signal 208 may be an example of the encoded signal 110 described in relation to FIG. 1A to FIG. 1E. The encoding stage 230 may be a component of a processing circuit (e.g., of the processing circuit 106, 250). Illustratively, the (analog) encoding stage 230 may be an example of the (analog) encoding stage 130 described in relation to FIG. 1A to FIG. 1E.

In some aspects, for providing the encoded signal 208, the processing circuit 250 (e.g., the encoding stage 230) may be configured to provide a cumulated signal 210 (sum(t), see the graph 200c in FIG. 2C) based on the plurality of quantized signals 204 and differentiate the cumulated signal 210 to provide a cumulated differential signal 212 (diff(t), see the graph 200d in FIG. 2D). Alternatively (not shown) the processing circuit 250 (e.g., the encoding stage 230) may be configured to differentiate each quantized signal of the plurality of quantized signals 204 to provide a plurality of differential signals, and provide a cumulated differential signal 212 by using the plurality of differential signals. Illustratively, the aspects described in relation to FIG. 2C and FIG. 2D may be carried out in the order shown in the figures or in inverse order to achieve the same result. The order of the summation and the differentiation stages can be switched. It may be possible (in view of the sum rule for derivatives) to do first a differentiation of the comparator outputs q1 (t), (q₂(t)), . . . , q_{L}(t) and then perform the summation of the differentiated comparator outputs. This may be beneficial depending on details of the circuit design.

The processing circuit 250 (e.g., the encoding stage 230) may include a summation stage 232 configured to provide the cumulated signal 210 (also referred to herein as aggregate signal 210) by summing the plurality of quantized signals 204 with one another. The task of the summation stage 232 may be understood as merging all the comparator output signals q1(t), q2(t), . . . , q_{L}(t) into a single signal for subsequent encoding. Illustratively, the summation stage 232 may be configured to merge together the quantized signals 204 (first to L-th, e.g first to seventh in the exemplary case shown in FIG. 2C) as, (5) sum(t)=q₁(t)+q₂(t)+ . . . +q_{L}(t)

The sum(t) signal may be seen as a discrete and quantified version of the input amplifier output signal s(t). The sum(t) signal may take a maximum of L+1 values. The summation stage 232 may be configured, at each time point, to sum the levels of the quantized signals 204 to provide a level of the cumulated signal 210. Assuming, for example, a level of 1 (in arbitrary units) in case a quantized signal 204 is at high level, and a level of 0 (in arbitrary units) in case a quantized signal 204 is at low level, the cumulated signal 210 may have at each time point a level provided by adding together the respective levels of each quantized signal 204. As shown in the exemplary case in FIG. 2C, the cumulated signal 210 may have a level of 1 for the portions of the received signal 202 in which the signal level is only greater than the first threshold level 206-1 (and thus only the first quantized signal 204-1 is at the high level), a level of 2 for the portions of the received signal 202 in which the signal level is also greater than the second threshold level 206-2, a level of 3 for the portions of the received signal 202 in which the signal level is also greater than the second threshold level 206-3, etc. A single cumulated signal 210 may be provided from the plurality of quantized signals 204.

In some aspects, the processing circuit (e.g., the summation stage 232) may be configured to sum the output signals of the plurality of comparators 222 to provide the cumulated signal 210. The summation stage 232 may be configured to receive the output signals of the plurality of comparators 222, and to sum the output signals with one another. As an example, the summation stage 232 may include at least one operational amplifier.

Providing the cumulated differential signal 212 may include determining the behaviour of the cumulated signal 210 over time, e.g. determining the portions of the cumulated signal 210 in which the cumulated signal 210 is increasing, decreasing, or remaining substantially flat (e.g., constant). Differentiating a signal (e.g., differentiating the cumulated signal 210, or differentiating a quantized signal 204 in case of inverted order of operations) may include assigning a different differential value to different portions of the signal in accordance with the behaviour of the signal. As the sum signal sum(t) may take L+1 values it is not very suitable for being captured and processed by a digital signal processing (DSP) chain. The differentiation may provide generating signals that take binary values in {0, 1}. Illustratively, the differentiation (and the subsequent polarity splitting) may provide encoding sum(t) adequately such that it can be represented by binary values in {0, 1}.

As shown in FIG. 2D, the processing circuit (e.g., the encoding 20 stage 230) may include a differentiation stage 234 configured to differentiate the cumulated signal 210 by assigning a first differential value (e.g., a value having a positive polarity, e.g. +1) to the portions of the cumulated signal 210 where the cumulated signal 210 is increasing, and assigning a second differential value (e.g., a value having a negative polarity, e.g. −1) to the portions of the cumulated signal 210 where the cumulated signal 210 is decreasing. In some aspects, the differentiation stage 234 may be configured to differentiate the cumulated signal 210 by assigning a third differential value (e.g., 0) to the portions of the cumulated signal 210 where the cumulated signal 210 is substantially flat. Illustratively, at the differentiation stage 234 the signal sum(t) is encoded by “differentiation”. Although the usage of the term differentiation may not be accurate in the strictest mathematical sense, it is essentially what is done.

In the exemplary case shown in FIG. 2D, the differentiation of the cumulated signal 210 may include assigning a first differential value 212-1 to the portions of the cumulated signal 210 at which the level of cumulated signal 210 increases from a lower level to a higher level (e.g., from 0 to 1, from 1 to 2, from 2 to 3, etc.). The differentiation of the cumulated signal 210 may include assigning a second differential value 212-2 to the portions of the cumulated signal 210 at which the level of cumulated signal 210 decreases from a higher level to a lower level (e.g., from 5 to 4, from 4 to 3, from 3 to 2, etc.). In some aspects, the differentiation of the cumulated signal 210 may include assigning a third differential value to the portions of the cumulated signal 210 at which the level of cumulated signal 210 remains substantially flat.

The resulting cumulated differential signal 212 may include one or more first differential values 212-1 and one or more second differential values 212-2. The one or more first differential values 212-1 may have an opposite polarity with respect to the one or more second differential values 212-2.

By way of illustration, the goal of the differentiation may be to encode the signal sum(t), which may be understood as a staircase-like signal, by a signal that can be captured and processed easily. The sum signal sum(t) may be sparse, i.e. it has many entries that can be neglected, and it is suitable to be represented by a binary signal afterwards. As the sum signal is a staircase signal, i.e. a signal with a few steep rises and declines and remaining signal portions that mostly flat, performing a differentiation on the sum signal may provide a sparse signal.

Denoting, for example, the differentiated version of the sum signal sum(t) with diff(t) (illustratively, the cumulated differential signal 212), and considering a staircase-like sum signal for differentiation, diff(t) may be represented by a value-discrete signal taking only values in {a, b, c}, where a is a positive number (first differential value) representing the portion of the signal where the edge is rising (which corresponds to a comparatively short time duration), b is zero (third differential value) representing the flat portion of the signal, and c is a negative number (second differential value) representing the portion of the signal where the edge is falling (which again corresponds to a comparatively short time duration). Thus, diff(t) may be provided as a sparse ternary signal.

As an exemplary implementation, the differentiation stage 234 may include a high-pass filter configured to receive the 10 cumulated signal 210 and output the cumulated differential signal 212. The high-pass filter may be or may include a low-order RC filter, with an adequately chosen time constant that fits to the time resolution of the fine TDC measurement stage for creating a suitable output signal. In other aspects, the differentiation stage 234 may include a plurality of high-pass filters configured to receive the plurality of quantized signals 204 and output a plurality of differential signals (which are then used to provide the cumulated differential signal 212). Each high-pass filter may be configured to receive a respective quantized signal and output a respective differential signal.

Providing the cumulated signal 210 and differentiating it (or providing the plurality of differential signals and then summing the differential signals to provide the cumulated differential signal) may provide a representation of the quantized signal 204 that ensures that the successive encoding (see FIG. 2E) provides an encoded signal 208 that enables processing in the digital domain (e.g., an encoded signal 208 that enables time-to-digital conversion).

As shown in FIG. 2E, providing the encoded signal 208 may include processing the cumulated differential signal 212 to obtain an unipolar signal. Illustratively, providing the encoded signal 208 may include rectifying the cumulated differential signal 212. The processing circuit (e.g., the encoding stage 230) may include a rectifier stage 236 configured to receive the cumulated differential signal 212 and rectify the cumulated differential signal 212. As an example, the rectifier stage 236 may include one or more rectifying diodes (e.g., coupled with a series resistor). The rectifier stage 236 may be dimensioned to also produce compatible digital output levels.

The rectifier stage 236 may be configured to output the encoded signal 208 including first encoded signal values 208-1 associated with the one or more first differential values 212-1, and including second encoded signal values 208-2 associated with the one or more second differential values 212-2. Illustratively, the first encoded signal values 208-1 may form a first unipolar signal 208p (p(t)) including the rectified one or more first differential values 212-1, and the second encoded signal values 208-2 may form a second unipolar signal 208n (n(t)) including the rectified one or more second differential values 212-2. The rectified one or more first differential values may have a same polarity as the rectified one or more second differential values (e.g., the rectified one or more first differential values and the rectified one or more second differential values may have a positive polarity, as shown in the graphs 200e).

Illustratively, a second part of the differentiation may be seen as splitting the differentiated signal into its positive and negative compounds and perform level conversion to be compatible with digital signal formats. The ternary signal diff(t) may be split into its positive and negative compounds. The polarity split may be done by simple rectification, e.g. by using fast diodes in conjunction with a series resistor. In the following, p(t) and n(t) may denote the positive and negative compounds of the differential signal diff(t), respectively.

In the representation in FIG. 2E, the encoded signal 208 is illustrated in two separate portions of the graph 200e, one associated with the first unipolar signal 208p (illustratively, associated with the portions where the cumulated signal 210 was increasing, e.g. the portions of positive slope in the received signal 202), and one associated with the second unipolar signal 208n (illustratively, associated with the portions where the cumulated signal 210 was decreasing, e.g. the portions of negative slope in the received signal 202). It is however understood, that the encoded signal 208 may also be represented (and provided) as a single signal including the first encoded signal values 208-1 and the second encoded signal values 208-2. The encoding stage 230 (e.g., the rectifier stage 236) may provide the encoded signal 208 as a single output (including both the first encoded signal values 208-1 and the second encoded signal values 208-2) or as two outputs (one including the first encoded signal values 208-1 and one including the second encoded signal values 208-2). It is understood that the determination of an encoded signal 208 illustrated in FIG. 2E is an example, and other approaches are possible, e.g. as described in relation to FIG. 1A to FIG. 1E. The merging of the first unipolar signal 208p and the second unipolar signal 208n into a single signal may provide a simple processing but may lead to a partial loss of information, and other approaches may be preferable depending on the implementation details.

In some aspects, e.g. in case of the encoded signal 208 being provided as single output, the processing circuit (e.g., the encoding stage 230) may be configured to delay the first unipolar signal 208p and the second unipolar signal 208n with respect to one another. Delay elements may be used to either delay p(t) or n(t) with respect to each other. This may provide that there is no undesired overlap between the first encoded signal values 208-1 and the second encoded signal values 208-2. For example, the delay may provide that p(t) and n(t) may be fed sequentially into a single fine TDC stage. A single fine TDC stage may be thus provided.

As an example, delaying p(t) or n(t) with respect to each other may be realized on the analog signal level by splitting the detected signal s(t) in two parallel paths. One of these paths may then be delayed on an analog level, e.g. by means of an analog tapped delay line. Both signals may then be fed into an array of edge detectors, e.g. one array active on rising edges, and one array active on falling edges, yielding the signals p(t) and n(t), respectively. As p(t) and n(t) are shifted to each other they may be inserted into a single TDC stage for capturing. As another example, delaying p(t) or n(t) with respect to each other may also be realized on the digital signal level, e.g. using an FPGA.

As an additional or alternative option (see also FIG. 1D and FIG. 1E) the processing circuit (e.g., the encoding stage 230, or the digitalization stage 240 described below) may be configured to provide the encoded signal 208 by mapping the differential values of the cumulated differential signal 212 to predefined symbols (or combinations of symbols). Illustratively, the processing circuit may be configured to provide the encoded signal 208 by representing the cumulated differential signal 212 using predefined (e.g., pre-stored) symbols associated with the possible differential values. The processing circuit may be configured to assign a first combination of binary symbols to each first differential value 212-1, a second combination of binary symbols to each second differential value 212-2, and a third combination of binary symbols to each third differential value. Providing the encoded signal 208 may include providing a sequence including the first combinations of binary symbols, the second combinations of binary symbols, and the third combinations of binary symbols.

Illustratively, one ternary symbol of the signal diff(t) in{a(t), b(t), c(t)} may be encoded onto two binary symbols in {0,1} for example as follows (the encoding may be selected 30 arbitrarily):
a(t)→‘11’;
b(t)→‘00’;
c(t)→‘10’ (or ‘01’).

By using such encoding procedure the signal diff(t) may be fully represented by an unipolar sequence of length 2·K, i.e. twice the length as compared to encoding p(t) and n(t). Other ways of encoding may also be provided, e.g. according to line codes used in communication systems engineering.

FIG. 2F shows a digitalization stage 240 and a digitalization of an encoded signal 208 according to various aspects. The graphs 200e and 200f in FIG. 2F may illustrate the provision of a digitized signal 214 from the encoded signal 208. The digitized signal 214 may be an example of the digitized signal 108 described in relation to FIG. 1A to FIG. 1E. The digitalization stage 240 may be part of a processing circuit (e.g., of the processing circuit 106, 250). Illustratively, the digitalization stage 240 may be an example of the digitalization stage 140 described in relation to FIG. 1A to FIG. 1E.

In some aspects, the digitalization stage 240 may be configured to receive a start signal 252, a stop signal 254, and a clock signal 256 for measuring a time-of-flight associated with the received signal 202, as described for the start signal 116, the stop signal 118, and the clock signal 114, respectively, in relation to FIG. 1A to FIG. 1G.

The processing circuit 250 (e.g., the digitalization stage 240) may be configured to perform a time-to-digital conversion of the encoded signal 208 (e.g., of the first unipolar signal 208p and of the second unipolar signal 208n) to provide the digitized signal 214. The digitized signal 214 may include first digitized values 214-1 (associated with the first encoded signal values 208-1) and second digitized values 214-2 (associated with the second encoded signal values 208-2).

The digitalization stage 240 may include one or more time-to-digital conversion stages 242, e.g. a first time-to-digital conversion stage 244 (e.g., a coarse stage) and a second time-to-digital conversion stage 246 (e.g., a fine stage) in the exemplary representation in FIG. 2F. At least one of the time-to-digital conversion stages 242 (e.g., the fine stage 246) may be configured to receive, at an input, the encoded signal 208 and to provide, at an output, the digitized signal 214 via time-to-digital conversion of the encoded signal 208. As an example, the one or more time-to-digital conversion stages 242 may include at least one of an application-specific integrated circuit (ASIC), a field programmable array (FPGA), or a FPGA-based tapped delay line. As another example, the one or more time-to-digital conversion stages 242 may include at least one tapped delay line. The tapped delay line may include a plurality of D-flip-flops and a plurality of delay elements, each delay element associated with a respective D-flip-flop.

In some aspects, the at least one time-to-digital conversion stage carrying out the time-to-digital conversion of the encoded signal 208 may be associated with all the comparators 222 of the plurality of comparators 222. Illustratively, the at least one time-to-digital conversion stage may ultimately receive (and process) a signal obtained from the outputs of all comparators 222 (via summation, differentiation, and encoding).

In some aspects, performing the time-to-digital conversion of the encoded signal 208 may include converting the first unipolar signal 208p into a first digitized signal 214p (\hat{p}(k)), the first digitized signal 214p including the first digitized values 214-1. In addition, performing the time-to-digital conversion of the encoded signal 208 may include converting the second unipolar signal 208n into a second digitized signal 214n (\hat{n}(k)), the second digitized signal 214n including the second digitized values 214-2. Illustratively, the digitized signal 214 may be understood, in some aspects, as being formed by the first digitized values 214-1 forming a first digitized signal 214p and by the second digitized values 214-2 forming a second digitized signal 214n. The digitized signal 214 may be provided (for further processing) as a single signal (as a single output of the digitalization stage 240) or as two separate signals (two separate outputs of the digitalization stage 240).

In the context of this description, \hat{p}(k) and \hat{n}(k) denote the discrete output sequences that represent the captured signals \hat{p}(t) and \hat{n}(t), respectively, where the integer k=1, 2, . . . , K is a running index to specify the order of signal samples within the sequences (note that k can be mapped to a time). K is an integer specifying the maximum length of the sequences, and may be defined by the implementation of the TDC stages. The sequences \hat{p}(k) and \hat{n}(k) with k=1, 2, . . . , K may be provided as outputs of at least one of the TDC stages 242 (e.g., of the fine stage 246).

It is understood that there may be other possibilities on how to represent the signals p(t) and n(t) as an output for downstream processing. Such representations may, for example, be based on the discrete output sequences \hat{p}(k) and \hat{n}(k) with k=1, 2, . . . , K. As the signals p(t) and n(t) are sparse, \hat{p}(k) and \hat{n}(k) with k=1, 2, . . . , K will also be sparse each containing only a few elements that are of relevance, illustratively those elements that indicate a rising or a falling edge in the sum signal sum(t). Therefore, it may be possible to only encode the relevant entries in either \hat{p}(k) or \hat{n}(k) with k=1, 2, . . . , K. Let Nₚ and Nₙ denote the number of relevant elements in \hat{p}(k) and \hat{n}(k) with k=1, 2, . . . , K, respectively. Then, \hat{p}(k) and \hat{n}(k) with k=1, 2, . . . , K may be represented by length-Nₚ and length-Nₙ vectors each including indices that specify the location of the significant elements in \hat{p}(k) and \hat{n}(k) with k=1, 2, . . . , K, respectively. These vectors may be provided as outputs of at least one of the TDC stages 242 (e.g., of the fine stage 246).

In some aspects, the one or more time-to-digital conversion stages 242 may provide a measurement of the time-of-flight associated with the received signal 202, as described in relation to FIG. 1A to FIG. 1G.

At least one of the TDC stages 242 (e.g., the first stage 244) may provide a coarse measurement of the time-of-flight. For example, the first stage 244 may be configured to receive the start signal 252 (start(t)) and the stop signal 254 (stop(t)), and generate internal digital signals to (stop_{coarse}(t)) and stop (stop_{coarse}(t)) the coarse TDC measurement. The first stage 244 may be configured to provide the coarse measurement T_{coarse} as quantified by the number N_{coarse} of counted clock cycles, based on the received clock signal 256 (clk(t)) and on the generated start signal (stop_{coarse}(t)) and stop signal (stop_{coarse}(t)).

At least one of the TDC stages 242 (e.g., the second stage 246) may provide a fine measurement of the time-of-flight. The second stage 246 may be configured to generate an internal digital signal (stop_{fine}(t)) to stop the fine TDC measurement, based on the stop signal 254 (stop(t)) and on the clock signal 256 clk(t). As an example, the second stage 246 may be configured to generate the internal digital signal (stop_{fine}(t)) in accordance with the active edge of the stop signal 254 (stop(t)) and the active edge of the clock signal 256 (clk(t)).

In some aspects, the TDC stage providing the fine measurement of the time-of-flight (e.g., the second stage 246) may be configured to define an extended time for the detection of the received signal 202, e.g. may define a time T_{capture} to prolong the detection, as described in relation to FIG. 1A to FIG. 1G. Let N_{capture} denote the number of clock periods Tclk provided to accommodate T_{capture}. Then, the active edge of (stop_{fine}(t) is defined by the (N_{capture}+1)-th active edge of the clock signal 256 (clk(t)) that follows the active edge of the stop signal 254 (stop(t)).

The second stage 246 may provide the result of the fine temporal measurement conducted at the end of Tₘₑₐₛ. The active edge of the input signal (stop_{fine}(t)) stops the fine measurement. The fine stage 246 may also be configured to provide the result of the fine temporal measurement T_{fine}, for example quantified by a number of elementary time units.

Let N_{fine} be the number of elementary time units (with a given 35 time duration) that represent T_{fine}.

Let kₛₜₐᵣₜ be the first (e.g., the smallest) index within the captured sequence \hat{p}(k) with k=1, 2, . . . , K that contains a relevant element. This index corresponds to the start time of the fine ToF measurement. In tapped-delay line implementation the index kₛₜₐᵣₜ may be the index of the D-flip flop furthest downstream in the chain that outputs a logical 1, i.e. it is the D-flip flop with the highest index in the numbering convention usually provided in the art.

Let kₛₜₒₚ denote the index within the captured sequence \hat{p}(k) with k=1, 2, . . . , K defined by the active edge of the stop signal 254 stop(t). In the tapped-delay line implementation, the index kₛₜₒₚ may be the first D-flip flop in the chain, i.e. it is the D-flip flop most upstream in the chain.

Then N_{fine} may be calculated based on the indices as follows, N_{fine}=kₛₜₒₚ−kₛₜₐᵣₜ.

Considering the tapped-delay line implementation, N_{fine} may be the index of the D-flip flop furthest downstream in the chain that outputs a logical 1. The fine stage 246 may be configured to provide N_{fine} as an output for determining the ToF measurement.

In some aspects, the digitized signal 214 may enable determining amplitude and/or shape information associated with the received signal 202.

The first digitized signal 214p may include information (in a digital representation) about the portions in which the signal level of the received signal 202 increases. Illustratively, the first digitized values 214-1 may have a first logic value in correspondence of the portions where the signal level of the received signal 202 becomes greater than one of the threshold levels 206 associated with the quantized signals 204, and a second logic value in correspondence of the remaining portions of the received signal 202. The first logic value may be a logic 1 and the second logic value may be a logic 0, as an example. It is understood that the first logic value and the second logic value may be defined arbitrarily. The first digitized signal 214p may include a sequence of logic values representing where the signal level of the received signal 202 increases.

Illustratively, the order of the logic values in the first digitized signal 214p represents the behavior over time of the signal level of the received signal 202 in terms of increments of signal level.

The second digitized signal 214n may include information (in a digital representation) about the portions in which the signal level of the received signal 202 decreases. Illustratively, the second digitized values 214-2 may have the first logic value (e.g. the logic 1) in correspondence of the portions where the signal level of the received signal 202 becomes less than one of the threshold levels 206 associated with the quantized signals 204, and the second logic value (e.g., the logic 0) in correspondence of the remaining portions of the received signal 202. The second digitized signal 214p may include a sequence of logic values representing where the signal level of the received signal 202 decreases. Illustratively, the order of the logic values in the second digitized signal 214p represents the behavior over time of the signal level of the received signal 202 in terms of decrements of signal level.

In some aspects, the processing circuit may be configured to determine amplitude information associated with the received signal 202 by combining the one or more first digitized values 214-1 with the one or more second digitized values 214-2. By way of example, the processing circuit may include one or more processors configured to process the digitized signal 214.

Combining the one or more first digitized values 214-1 with the one or more second digitized values 214-2 may include providing a cumulated summation signal. The processing circuit 250 may be configured to provide the cumulated summation signal by incrementing a cumulated signal value in correspondence of each first logic value of the one or more first digitized values 214-1 and decrementing the cumulated signal value in correspondence of each first logic value of the one or more second digitized values 214-2. Illustratively, the cumulated summation signal may be understood as a sequence of values that starts from an initial value (e.g., 0), increases (e.g., by a predefined amount, for example by 1) for each logic 1 in the sequence of digitized values in the first digitized signal 214p, and decreases (e.g., by the predefined amount) for each logic 1 in the sequence of digitized values in the second digitized signal 214n. The cumulated summation signal may be a staircase-like signal, whose behavior is defined by the first digitized signal 214p and the second digitized signal 214n.

The original signal 202 may be reconstructed using the captured sequences \hat{p}(k) and \hat{n}(k) with k=1, 2, . . . , K, or using any other suitable output representation. For example, the cumulated signal 210 sum(t) may be reconstructed considering that the captured sequences p(t) and n(t) were obtained by differentiation of sum(t) which can be reversed by performing an integration. Let [symbol] (k) denote a sequence that represents the sum signals sum(t) where the integer k=1, 2, . . . , K is a running index, and K is the maximum length of the sequence. In the discrete case the integration becomes a summation and [symbol] (k) may be derived by summation as follows,

[symbol]

(k)=Σₘ₌₁^{k}(\hat{p}(m)−\hat{n}(m)), (6)

Let ŝ(k) denote a sequence that represents the detected signal 202 (s(t)) where the integer k=1, 2, . . . , K is a running index, and K is the maximum length of the sequence. Then, ŝ(k) may be determined by a mapping assignment (essentially inversing the quantization stage). The assignment may be formulated as follows,

for k=1, 2, . . . , K, assign 1← [symbol] (k), and assign ŝ(k)←ref₁.

Illustratively, in some aspects, the processing circuit 250 may be configured to determine amplitude information associated with the received signal 202 by assigning to each cumulated signal value one reference value 206 of the plurality of reference values 206 associated with the plurality of comparators 222. The processing circuit 250 may determine amplitude information by converting the cumulated signal values into signal level (e.g., into amplitude).

In some aspects, the processing circuit 250 may be configured to reconstruct the shape of the received signal 202 by using the cumulated summation signal. The reconstruction of the shape of the received signal 202 may include approximating the (continuous) shape of the received signal 202 based on the (discrete) representation provided by the cumulated summation signal.

In some aspects, the processing circuit 250 may be configured to use the additional information extracted from the digitized signal 214 for refining the time-of-flight measurement. For example, the processing circuit 250 may be configured to adjust a result of the time-of-flight measurement by using the reconstructed shape of the received signal 202. Knowing the shape of the detected signal 202 (e.g., of a detected pulse) the ToF measurement, as obtained by the coarse and fine TDC measurements, may be refined possibly also taking into account knowledge about the emitted pulse shape. For example, this may provide reducing the so-called walk-error typically found in conventional TDC-based ToF measurement schemes.

The processing circuit 250 may be configured to identify one or more relevant portions in the reconstructed shape of the received signal 202 based on a known shape of the received signal 202, and to determine one or more respective time offsets between the start of the time-of-flight measurement and each of the one or more relevant portions. The shape of the detected pulse 202 as captured by the fine TDC stage 246 may be known (e.g., predefined), and the processing circuit 250 may be configured to identify the relevant portions in the captured signal 202 that most closely represent an emitted pulse according to some criteria. The identification of the portions may be carried out in various ways, for example: (1) middle of the pulse: half distance between the first rising and the last rising edge; (2) peak of the pulse: half distance between the highest rising edge and the highest falling edge; (3) highest rising edge: time defined by the highest rising edge; (4) correlation fit: best cross correlation of the emitted pulse within the detected pulse; (5) and others.

After identifying these portions the processing circuit 250 may be configured to identify the time offset between the start of the fine measurement and the identified portion. For example, this can be done based on the index kₛₜₐᵣₜ that defines the start of the ToF measurement calculating the difference to the indices of the identified signal portions, which essentially corresponds to a time offset. This time offset can then be used to refine the ToF measurement. The processing circuit 250 may be configured to adjust the result of the time-of-flight measurement by using the one or more determined time offsets.

In some aspects, the processing circuit 250 may be configured to dynamically adapt the threshold levels 206 associated with the quantized signals 204 (e.g., the reference values 206 associated with the comparators 222). The processing circuit 250 may be configured to adapt the threshold levels 206 associated with the quantized signals 204 based on at least one of: a time-of-flight associated with the received signal 202, a reconstructed amplitude or shape of the received signal 202, and/or one or more environmental conditions. The adaptation of the threshold levels 206 may provide adapting the encoding and digitalization process to the current scenario (e.g., a currently emitted signal, a current environment surrounding the detection system, etc.), thus improving the accuracy of the measurement.

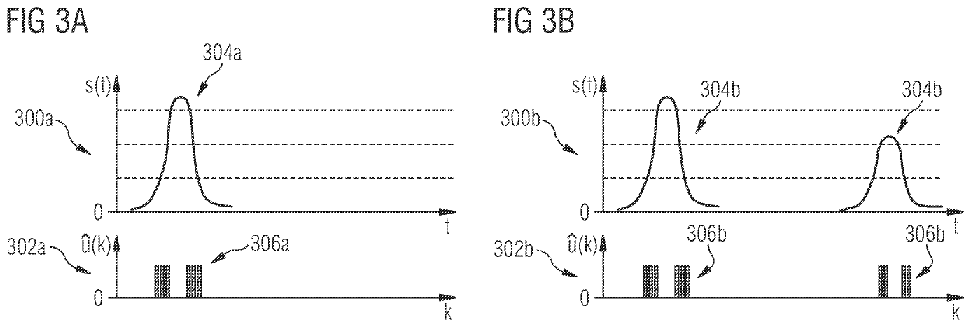

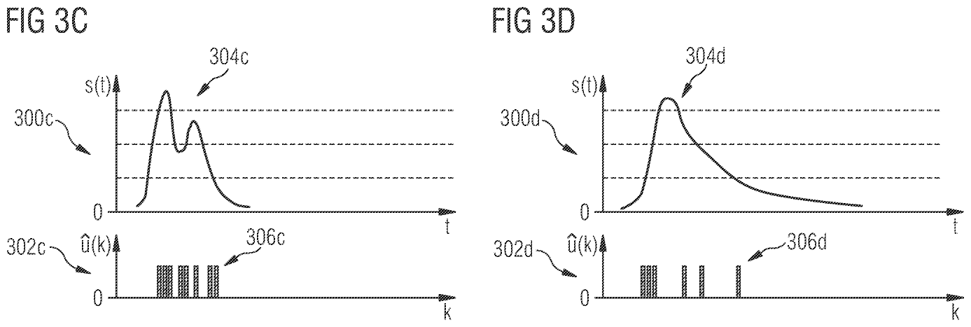

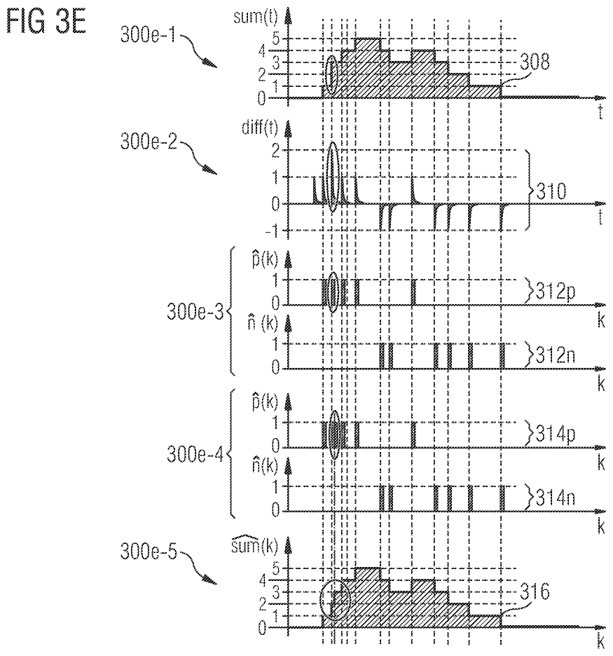

Additional aspects that may optionally be provided in relation to the signal detection and processing will be described in relation to FIG. 3A to FIG. 3E.

FIG. 3A, FIG. 3B, FIG. 3C, and FIG. 3D illustrate respective graphs 300a, 300b, 300c, 300d, 302a, 302b, 302c, 302d associated with signal-shape inference.

In some aspects, a processing circuit (e.g., the processing circuit 106, 250 described in relation to FIG. 1A to FIG. 2F) may be configured to transform a cumulated differential signal diff(t) (e.g., the cumulated differential signal 212) into a unipolar signal u(t) by calculating its magnitude such that u(t)=|diff(t)|, instead of splitting the cumulated differential signal into its positive (p(t)) and negative (n(t)) components. As an example, the transformation may be carried out by rectifying the cumulated differential signal (diff(t)) to obtain the unipolar signal (u(t)).

In this configuration, only one signal (the unipolar signal u(t)) is then captured by the one or more time-to-digital conversion stages (e.g., by the fine stage 246 described in relation to FIG. 2F). A single fine TDC stage may be implemented, thus reducing the overall complexity. Information may be lost during encoding such that rising or falling edges in the original sum signal sum(t) (e.g., the cumulated signal 210 described in relation to FIG. 2D) cannot be distinguished when reconstructing the sequence representing the received signal (illustratively, the sequence s\hat{ }(k)). The processing circuit may be configured to determine (e.g., to infer) the shape of the received signal by using knowledge about a typical detected signal (e.g., a typical LIDAR signal) as auxiliary information. Illustratively, the processing circuit (e.g., the processing circuit 106, 250 described in relation to FIG. 1A to FIG. 2F) may be configured to reconstruct the shape of the received signal (e.g., the received signal 104, 202) by comparing the cumulated summation signal with a plurality of known cumulated summation signals. The shape may be reconstructed in case a match is found, e.g. based on a level of confidence for the match.

The graphs 300a, 300b, 300c, 300d in FIG. 3A to FIG. 3D illustrate exemplary signals 304a, 304b, 304c, 304d that may be received at a detection system (e.g., at the detector 102, 201 of a detection system 100), e.g. a single pulse signal 304a, a signal 304b with distinct pulses, a double pulse signal 304c, or a signal 304d with a broad pulse. The graphs 302a, 302b, 302c, 302d in FIG. 3A to FIG. 3D illustrate exemplary unipolar signals 306a, 306b, 306c, 306d (denoted as u(k)) associated with the exemplary signals 304a, 304b, 304c, 304d, upon processing the exemplary signals 304a, 304b, 304c, 304d. From the graphs 302a, 302b, 302c, 302d it may be seen that pulses of the different categories (single pulse, double pulse, or two distinct pulses) have very distinct pattern in the distribution of u(k), thus allowing inferring the category of a captured signal. Knowing the pulse category the signal shape (e.g., the pulse shape) can then be reconstructed using the captured timing information.

In some aspects, the inference process may be implemented adopting advanced machine learning or clustering concepts.

Alternatively or additionally, the inference process may be implemented using heuristic approaches, for example using a tailored mapping table.

FIG. 3E shows a series of graphs 300e-1, 300e-2, 300e-3, 300e-4, 300e-5 illustrating a processing of a received signal.

Depending on the application and the properties of the detected signal and on the dimensioning of the TDC stage converting the encoded signal (e.g., the fine TDC stage 246 described in relation to FIG. 2F), the situation may occur where a steep edge in the detected signal causes several comparators (e.g., one or more of the comparators 222, each operating at a different comparator threshold) to toggle their outputs at virtually the same time. Illustratively, the comparators may toggle their output in very short temporal succession such that the toggle time instants cannot be resolved by the fine TDC stage any longer.

In this case, as shown in the graph 300e-1, some of the edges in the cumulated signal 308 sum(t) (e.g., an example of the cumulated signal 210) would not be captured in the sequences \hat{p}(k) and \hat{n}(k) with k=1, 2, . . . , K. For example, two edges in the sum signal 308 sum(t) may be mapped onto a single pulse \hat{p}(k) or \hat{n}(k) for some k. As shown in the graphs 300e-1 to 300e-3, for example, two edges in the sum signal 308 sum(t) are mapped onto a single pulse \hat{p}(k) of the digitized signal 312p for some k (e.g., following the differentiation providing the cumulated differential signal 310 diff(t), and the TDC conversion to provide the first and second digitized signals 312p, 312n).

To prevent this possible issue, in some aspects, the processing circuit may be configured to encode steep edges by a corresponding number of subsequent pulses. This configuration may provide that edges are not lost during the capturing process, and amplitudes may be reconstructed accurately, at the cost of a slight temporal imprecision regarding these edges, illustratively the edges may then be slightly shifted with respect to each other.

As shown for example in the graph 300e-4, providing the digitized signals 314p, 314n may be adapted in such a way that two edges in the sum signal 308 sum(t) are represented by two subsequent pulses in the first digitized signal 314p \hat{p}(k) with k=1, 2, . . . , K. The graph 300e-5 shows the reconstructed signal 316 [symbol] (k) with k=1, 2, . . . , K, showing slight temporal imprecisions regarding the two edges under consideration.

The implementation on how to encode steep edges by a corresponding number of subsequent pulses may be done in different ways. As an example, considering a high-pass filter implementation of the differentiation stage, it may be done by dimensioning the time constant of the high-pass filter together with the chosen thresholds for the digitization stage in order to map the amplitude of the differential signal diff(t), whose amplitude depends on the height of the edges (assuming the time duration of the edge transition stays the same), onto a proportional time duration which ideally may be expressed by multiples of the fine TDC temporal resolution.

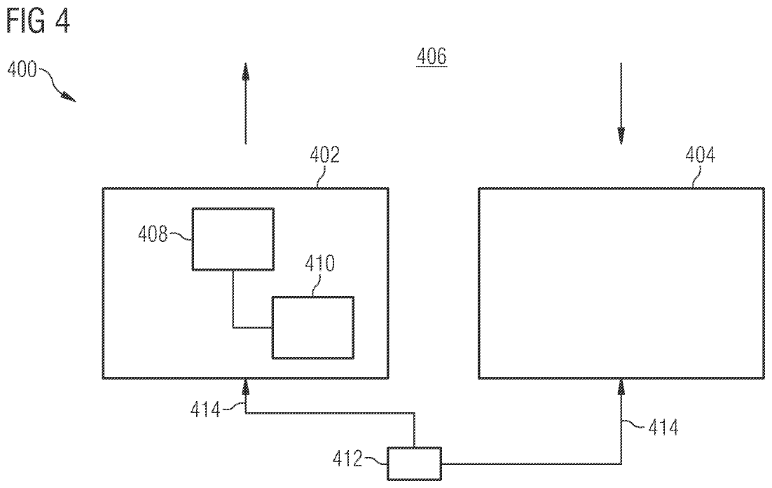

FIG. 4 shows a LIDAR system 400 in a schematic view according to various aspects. The LIDAR system 400 may include a light emission system 402 and a light detection system 404. The light detection system 404 may be configured as described herein, e.g. may be configured as the detection system 100 described in relation to FIG. 1A to FIG. 1E. The light emission system 402 may be configured to emit light (in a field of view 406 of the LIDAR system 400), and the light detection system 404 may be configured to detect the light emitted by the light emission system 402 (from the field of view 406).

The light emission system 402 may be configured to emit a light signal, e.g. a light signal including one or more light pulses. The light emission system 402 may include a light source 408 configured to emit light having a predefined wavelength, for example in the infra-red and/or near infra-red range, such as in the range from about 700 nm to about 5000 nm, for example in the range from about 860 nm to about 1600 nm, or for example at 905 nm or 1550 nm. The light source 408 may be configured to emit light in a pulsed manner, for example the light source 408 may be configured to emit one or more light pulses (e.g., a sequence of light pulses). In some aspects, the light source 408 may include an optoelectronic light source (e.g., a laser source). As an example, the light source 408 may include one or more light emitting diodes. As another example the light source may include one or more laser diodes, e.g. one or more edge-emitting laser diodes or one or more vertical cavity surface emitting laser diodes. The light source 408 may be configured to emit one or more laser pulses, e.g. a sequence of laser pulses.

The light emission system 402 may include a light source driver 410 (e.g., an electronic driver circuit) configured to control an emission of light by the light source 408. The light source driver 410 may be configured to provide a driving signal to the light source 408 to prompt (e.g., to trigger, or to start) an emission of light by the light source 408.

In some aspects, data may be encoded in an emitted light signal.

The light source driver 410 may be configured to control an emission of light by the light source 408 to encode data in the emitted light, e.g. according to a data communication protocol. Data communication protocols may be formulated that use information in the amplitude and/or the pulse-shape to encode data (e.g. ID information, data traffic, or signaling messages) in addition to the LIDAR ranging signals.

The task of the light emission system 402 (also referred to herein as emitter) may be understood as providing an optical output pulse with the desired properties. Among others, the output pulse duration, the pulse peak power, and the pulse shape may be adapted for LIDAR applications.

In some aspects, the LIDAR system 400 may include a clock signa generator 412 configured to generate a clock signal 414. As an example, the clock signal generator 412 may include an oscillator and one or more phase-locked loops. The clock signal generator 412 may be configured to provide a common clock signal 414 to the light emission system 402 and the light detection system 404.

The light source driver 410 may be configured to control the emission of light by the light source 408 in accordance (e.g., in synchronization) with the common clock signal 414. This may provide a synchronized operation of light emission and detection, and a simplified measurement of the time-of-flight of the emitted light (as described in relation to FIG. 1F and FIG. 1G).

In some aspects, the light source driver 410 may be configured to receive a start signal (start(t), see FIG. 1F and FIG. 1G) indicating that emission of light should be initiated. The light source driver 410 may receive the start signal from a circuit or module external to the light emission system 402, e.g. from a measurement control circuit of the LIDAR system 400. The light source driver 410 may be configured to control the light emission by the light source 408 in response to the start signal received at the light source driver 410. The start signal may be synchronized with the common clock signal 414. Only as an example a rising edge of the start signal may be synchronized with a rising edge of the common clock signal 414 (see also FIG. 1G). Illustratively, the driver may be triggered from the outside by an electric signal that allows for a synchronized emission of the optical output pulse.

In some aspects, the amplitude and/or shape information provided by the reconstruction of the signal received at the light detection system 404 may provide for a dynamic adaptation of the ranging schemes implemented in the LIDAR system 400. The availability of amplitude information makes it possible to flexibly react based on measurements of the environmental conditions. It may be possible to adjust system settings over time and be adaptive. This may improve the system performance, e.g. the power efficiency, or may render the system more versatile and thus robust in a variety of situations.

The light source driver 410 may be configured to control the light emission by the light source 408 in accordance with the amplitude and/or shape information provided by the light detection system 404. As an example, the light source driver 410 may be configured to control the light source 408 to emit a further light signal having increased optical power in case the amplitude information provided by the light detection system 402 indicates that the amplitude of the received light signal is less than a predefined threshold (or with reduced optical power in case the amplitude is above another threshold). This configuration may ensure that safety requirements are fulfilled, while ensuring sufficient optical power for detecting objects (e.g., obstacles) in the field of view 406. Illustratively, an amplitude-dependent power control may be implemented. The light emission system 402 may start with a configuration where not the full optical power is emitted (e.g., to provide an overview shot). After identifying areas in the field of view 406 which have a low received signal strength (low amplitude), the power may be increased for these areas in the field of view 406 to obtain better results for the next measurement. This adaptive approach may provide more flexible trade-offs of range/signal integrity versus power consumption/eye safety.

As another example, the processing circuit of the light detection system 404 may be configured to adapt a number of signal averaging cycles based on the amplitude information. Illustratively, an amplitude-dependent signal averaging may be provided. The amplitude-information may be used to adjust the number of signal averaging cycles at the detector that is used to improve the signal-to-noise ratio. A trade-off may be provided between range/signal integrity versus refresh rate.

As a further example, the light emission system 402 may be configured to control an emission direction of the light based on the amplitude information. The light emission system 402 may include a beam steering element (e.g., a liquid crystal polarization grating, LCPG), and may be configured to control the beam steering element in accordance with the amplitude information. Illustratively, amplitude-dependent coarse beam steering (LCPG control) may be provided. The information about the received amplitude may be used to adjust the coarse scanning pattern, e.g. as used in LCPG-based systems. A trade-off may be provided between range/signal integrity versus field of view coverage.

In a similar manner, the shape of the received light (e.g., the pulse-shape) may be used to further analyze the environmental conditions or the current target object to adjust system settings over time and be adaptive. This may improve system performance, e.g. power efficiency, or may make the system more versatile and thus robust in a variety of situations.

It is understood that the aspects described in FIG. 4 in relation to the light emission system 402 and the emitted light signal may apply in a same or similar manner to an emission system configured to emit another type of signal, e.g. to an ultrasonic module configured to emit an ultrasonic signal, to a RADAR module configured to emit a RADAR signal, etc.

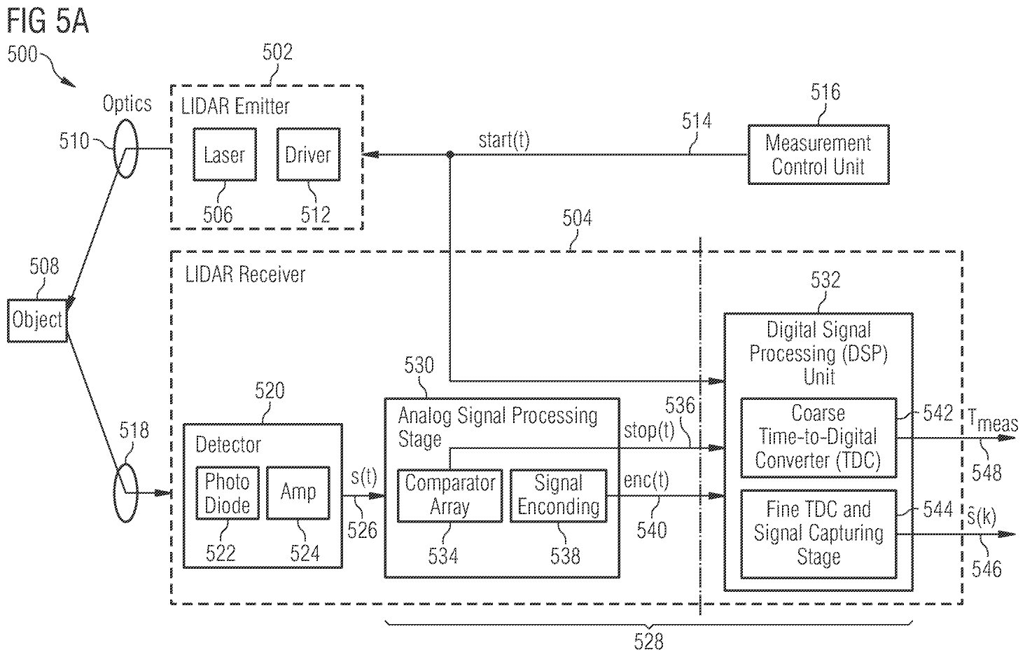

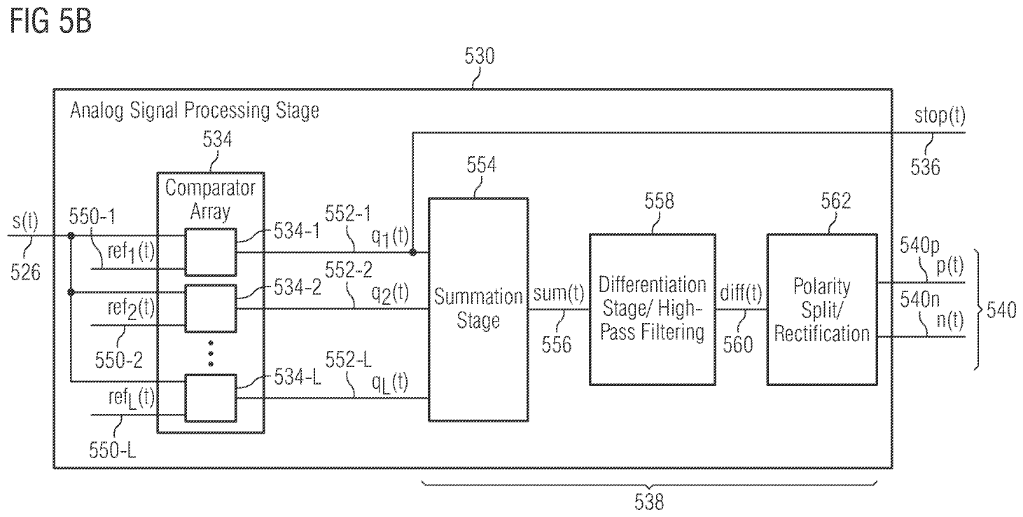

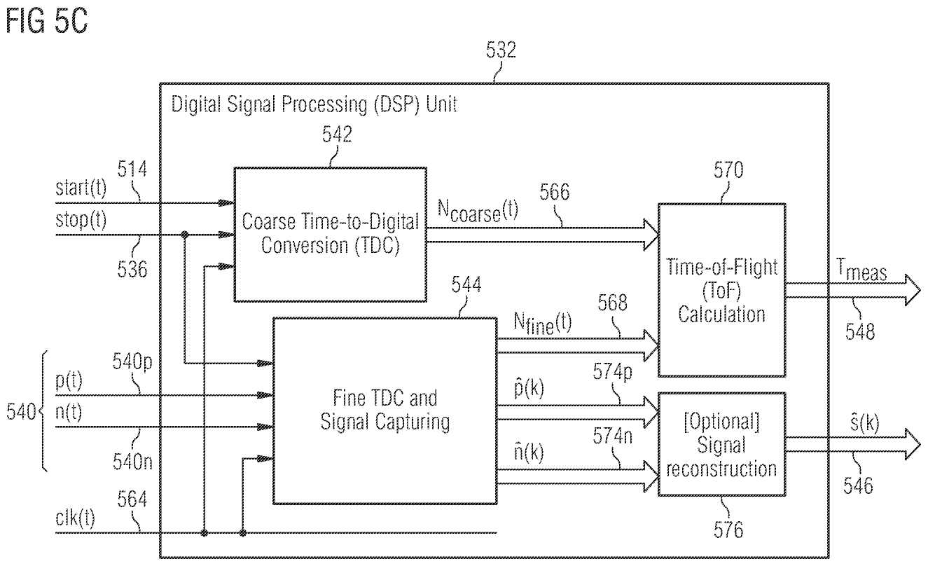

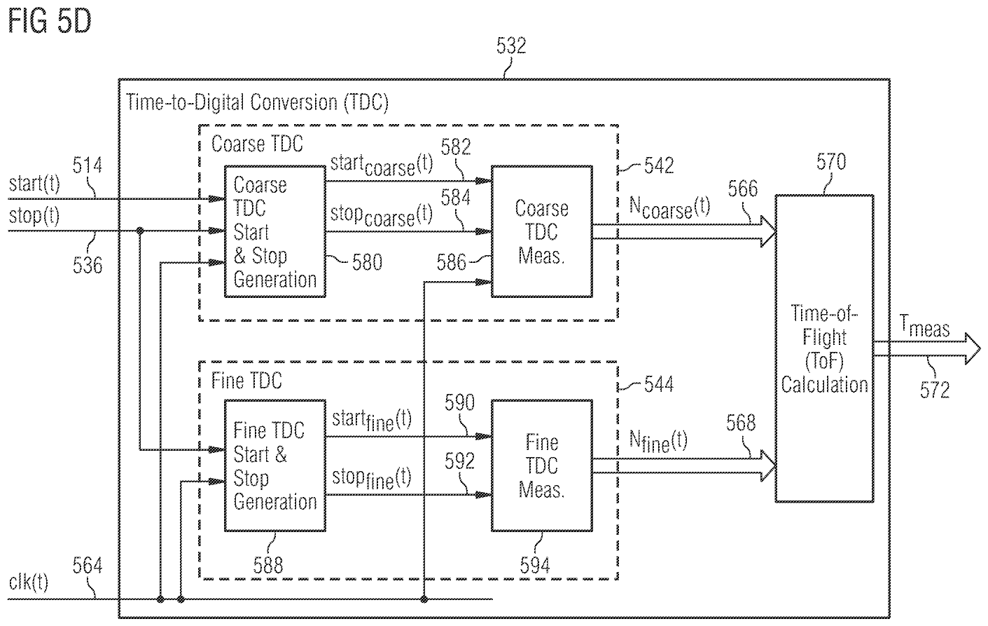

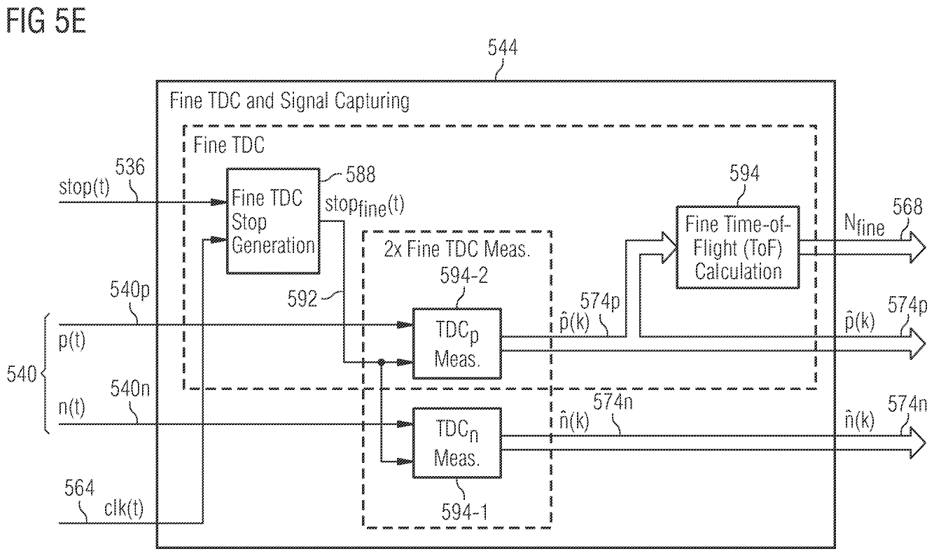

FIG. 5A shows a LIDAR system 500 in a schematic view according to various aspects. The LIDAR system 500 may include a LIDAR emitter 502, and a LIDAR receiver 504. The LIDAR system 500 may be an exemplary implementation of the LIDAR system 400 described in FIG. 4, the LIDAR emitter 502 may be an exemplary implementation of the light emission system 402 described in relation to FIG. 4, and the LIDAR receiver 404 may be an exemplary implementation of the detection system 100, 402 described in relation to FIGS. 1A-1E and FIG. 4.

The LIDAR emitter 502 may include a laser source 506 (e.g., an example of the light source 408 described in FIG. 4) to emit light towards a field of view of the LIDAR system 500, e.g. towards an object 508 in the field of view. The LIDAR system 500 may include an emitter optics arrangement 510 (e.g., one or more lenses, mirrors, etc.) configured to direct the light emitted by the laser source 506 towards the field of view.

The LIDAR emitter 502 may include a driver 512 (e.g., an example of the light source driver 410 described in FIG. 4) configured to control the emission of laser light by the laser source 506. The driver 512 may be configured to receive a start signal 514 (start(t)) from an external circuit, e.g. a measurement control circuit 516 (also referred to herein as measurement control unit).

At the receiver side, the LIDAR system 500 may include a receive optics arrangement 518 (e.g., one or more lenses, mirrors, etc.) configured to collect light from the field of view (e.g., light reflected from the object 508) and to direct the collected light towards the LIDAR receiver 504.

The LIDAR receiver 504 may include a detector 520 (e.g., an example of the detector 102, 201 described in FIGS. 1A-1E and FIG. 2A) configured to provide a received light signal 526 (s(t)). The detector 520 may include a photo diode 522 configured to generate a current signal in response to the light signal impinging onto the photo diode, and an amplifier 524 (e.g., a transimpedance amplifier) configured to amplify the current signal and convert it into a voltage signal, to provide the received light signal 526 (s(t)).

The LIDAR receiver 504 may include a processing circuit 528 (e.g., an example of the processing circuit 106, 250 described in relation to FIG. 1A to FIG. 2F) configured to process the received light signal 526. The processing circuit 528 may include an analog signal processing stage 530 and a digital signal processing stage 532 (also referred to herein as digital signal processing unit). The analog signal processing stage 530 may be an example of the quantization stage 120, 220 and encoding stage 130, 230 described in relation to FIG. 1A to FIG. 2F. The digital signal processing stage 532 may be an example of the digitalization stage 140, 240 described in relation to FIG. 1A to FIG. 2F.

The analog signal processing stage 530 may include a comparator array 534 configured to provide a quantized representation of the received light signal 526. The output of at least one of the comparators of the comparator array 534 may be provided as stop signal 536 (stop(t)) for stopping the time-of-flight measurement. The analog signal processing stage 530 may include a signal encoding stage 538 configured to encode the quantized representation of the received light signal and provide an encoded signal 540 (enc(t)) to the digital signal processing stage 532.

The digital signal processing stage 532 may include a coarse time-to-digital converter stage 542 and a fine time-to-digital and signal capturing stage 544 (e.g., an example of the first and second time-to-digital conversion stages 244, 246 described in relation to FIG. 2F). The digital signal processing stage 532 may be configured to provide a reconstructed signal 546 s\hat{ }(k), providing a reconstructed representation of the received light signal. The digital signal processing stage 532 may be configured to provide a time measurement signal 548 representative of a time-of-flight associated with the emitted/received light signal.

FIG. 5B shows an exemplary implementation of the analog signal processing stage 530 in a schematic view according to various aspects.

The comparator array 534 may include a plurality of comparators, e.g. first to L-th comparators 534-1, 534-2, . . . , 534-L in the configuration in FIG. 5B, each associated with a respective one of a plurality of reference values, e.g. first to L-th reference values 550-1, 550-2, . . . , 550-L (ref1(t), ref2(t), . . . , ref_{L}(t)). The plurality of comparators may provide a plurality of quantized

20 signals as outputs, e.g. first to L-th quantized signals 552-1, 552-2, . . . 552-L q_{L}(t), q2(t), . . . , q_{L}(t)). One of the outputs of the comparators may be provided as stop signal 536 stop(t), e.g. the first output 552-1 of the first comparator 534-1 (e.g., the comparator having the smallest associated reference value, for example).

The signal encoding stage 538 may include a summation stage 554 (e.g., an example of the summation stage 232 described in relation to FIG. 2C) configured to provide a sum signal 556 (sum(t)) by summing the outputs of the comparators. The signal encoding stage 538 may include a differentiation stage 558 (e.g., an example of the differentiation stage 234 described in relation to FIG. 2D) configured to differentiate the sum signal 556 to provide a cumulated differential signal 560 (diff(t)), e.g. the differentiation stage 558 may be understood as a high-pass filtering stage. The signal encoding stage 538 may include a polarity split and rectification stage 562 (e.g., an example of the rectifier stage 236 described in relation to FIG. 2E) configured to provide the encoded signal 540, e.g. by splitting and rectifying the cumulated differential signal 560. The encoded signal 540 may include a first encoded signal 540p (with first encoded signal values) and a second encoded signal 540n (with second encoded signal values), as described above.

FIG. 5C shows an exemplary implementation of the digital signal processing stage 532 in a schematic view according to various aspects.

The coarse TDC stage 542 may receive the start signal 514 (start(t)), the stop signal 536 (stop(t)), and a clock signal 564, and may provide the coarse time measurement signal 566 based on the start signal 514, the stop signal 536, and the clock signal 564. The coarse time measurement signal 566 may include a number of clock cycles (N_{coarse} (t)) between the start signal 514 and the stop signal 536.

The fine TDC stage 544 may receive the stop signal 536 and the clock signal 564, and may provide the fine time measurement signal 568 based on the stop signal 536 and the clock signal 564. The fine time measurement signal 568 may include a number N_{fine} of elementary time units (with a given time duration) that represent the fine time T_{fine}.

The digital signal processing stage 532 may include a time-of-flight calculation stage 570 configured to receive the coarse time measurement signal 566 and the fine time measurement signal 568, and to calculate the time-of-flight associated with the emitted/received light signal based on the coarse time measurement signal 566 and the fine time measurement signal 568. The time-of-flight calculation stage 570 may be configured to provide the measurement signal 548 representing the determined time-of-flight.

The fine TDC stage 544 may further receive the encoded signal 540 (e.g., the first and second encoded signals 540p, 540n), and may be configured to carry out a time-to-digital conversion of the encoded signal to provide a digitized signal (e.g., including a first digitized signal 574p \hat{p}(k), and a second digitized signal 574n \hat{n}(k)).

Optionally, the digital signal processing stage 532 may include a signal reconstruction stage 576 configured to provide the reconstructed signal 546 ŝ(k) representing the reconstructed received light signal, based on the first digitized signal 574p \hat{p}(k) and the second digitized signal 574n \hat{n}(k).

FIG. 5D shows a further exemplary implementation of the digital signal processing stage 532 in a schematic view according to various aspects.

In the configuration shown in FIG. 5D it is illustrated that the coarse stage 542 and the fine stage 544 may include two “sub-stages” for performing the respective coarse and fine time measurement.

The coarse stage 542 may include a coarse start and stop generation stage 580 configured to generate internal digital signals, e.g. a coarse digital start signal 582 (start_{coarse}(t)) and a coarse digital stop signal 584 (stop_{coarse}(t)), to start and stop the coarse TDC measurement. The coarse stage 542 may include a coarse measurement stage 586 configured to provide the coarse measurement signal 566 based on the internal digital start and stop signals 582, 584.

The fine stage 544 may include a fine start and stop generation stage 588 configured to generate internal digital signals, e.g. a fine digital start signal 590 (start_{fine}(t)) and a fine digital stop signal 592 (stop_{fine}(t)), to start and stop the fine TDC measurement. The fine stage 544 may include a fine measurement stage 594 configured to provide the fine measurement signal 568 based on the internal digital start and stop signals 590, 592.

FIG. 5E shows a further exemplary implementation of the fine stage 544 in a schematic view according to various aspects.

In the configuration shown in FIG. 5E it is illustrated that the fine measurement stage may include a plurality of sub-stages (e.g., two fine measurement sub-stages 594-1, 594-2) for time-digital conversion of the encoded signal 540, e.g. in case the encoded signal 540 is provided as two separate signals 540p, 540n. A first sub-stage 594-1 may be associated with the time-digital conversion of the first encoded signal 540p to provide the first digitized signal 574P \hat{p}(k), and a second sub-stage 594-2 may be associated with the time-digital conversion of the second encoded signal 540n to provide the second digitized signal 574n \hat{n}(k).

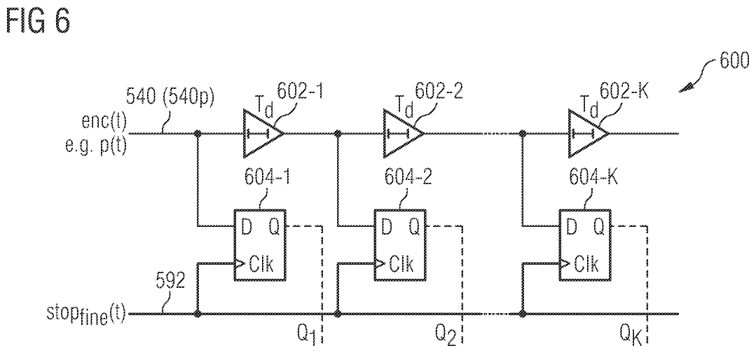

FIG. 6 shows a tapped delay line 600 in a schematic view according to various aspects. The tapped delay line 600 may be an exemplary implementation of a time-to-digital conversion stage, e.g. of a fine stage (for example of the fine stage 246, 594, 594-1, 594-2 described in relation to FIG. 2F, and FIG. 5C to FIG. 5E).

In general, TDCs can be implemented analog or digitally. Analog approaches use time amplifier (TA) or time to voltage converter (TVC) to achieve high resolution, but these methods are silicon area-consuming and with, higher cost, lower conversion rate, and higher power consumption compared with digital approaches. In a digital TDC, high resolution may be achieved by using the gate delay of the delay cell as TDC's quantization step. Several structures may be provided for implementing a digital TDC, such as a single stage linear delay line, which can achieve wide range by sacrificing chip area, a Phase Locked Loop (PLL) and Delay Locked Loop (DLL), or a Vernier Delay Line (VDL), which may provide excellent resolution but also suffer from large chip area if wide range is to be provided. A DLL may provide stability and fast locking time.

In the exemplary configuration in FIG. 6 a TDC is provided as a tapped delay line. It is however understood that other configurations may be provided, as described above.

The tapped-delay line 600 may include K cascaded delay elements 602-1, 602-2, . . . , 602-k, whose inputs are stored in D-Flip Flops (DFFs) 604-1, 604-2, . . . , 604-K. Illustratively, the tapped delay line 600 may include as many DFFs as delay elements. Each delay element may regrouped with its associated DFF to form an elementary cell of the TDC. The number K of the elementary cells may be chosen depending on the clock period Tclk, as well as the propagation time Td of the delay element. The number K may be expressed as the ratio of clock period to propagation time Td. For example, the propagation time Td may be determined experimentally.

In some aspects, a digital TDC may be implemented in an ASIC or FPGA device. For example, in ASIC, various ways may be implemented, such as time counters, oscillators, pulse shrinkers, delay lines and Vernier lines. However, the design process of an ASIC device may be expensive, especially if produced in small quantities, while FPGAs lower the development cost and offer more design flexibility. On the other hand, the design of high-resolution TDCs using FPGAs may be limited mostly due to the FPGA slice structure. Although it is possible to implement reconfigurable versions of TDC oscillators and time counters, they are limited in use due to low resolution or demanding calibration requirements

Considering a tapped-delay line TDC implementation, the carry chain in FPGAs may be used instead of inverters or buffers, as it is the only structure with a dedicated routing path, i.e. the signal is not routed through the switch boxes, it is the structure with the smallest delay. Furthermore, the routing may be independent of the compiler making the delay stable with each compile run. The main limitations may be those coming with the FPGA slice structure: the clock domains, clock slew and slack, the carry-look-ahead and the non-uniform delay inter and intra carry slices. However, FPGA-based tapped-delay line TDC implementations may provide a resolution in the sub-nanosecond range down to a few picoseconds, which is suitable for LIDAR applications.

According to various aspects of the present disclosure an adapted TDC-based LIDAR architecture is provided that is capable of capturing amplitude and pulse-shape information, thus essentially combining the advantages of a TDC and a full waveform sampling solution. The output of a comparator array may be encoded in a way that allows capturing it by two parallel TDC stages, possibly realized by delay lines, that are capable to capture high-speed signals in sub-nanosecond scale. The pulse-shape may be subsequently reconstructed from the pattern captured by the two TDC stages. In some aspects, a more simplified solution requiring only a single TDC stage is provided, which allows for pulse-shape inference taking into account knowledge about typical LIDAR pattern as auxiliary-information.

By using the approach described herein, it becomes possible to capture information about the amplitude and the pulse-shape of a detected signal. This may provide various advantages, as described above, and for example the walk-error of a time-of-flight measurement can be reduced by using the captured pulse-shape for refining the time-of-flight measurement to achieve better ranging performance.

The proposed architecture allows for a low-complexity and cost-effective implementation (particularly as compared to full waveform sampling solutions using high-speed ADCs). The solution may be implemented taking into account practical aspects like splitting the TDC into a coarse and fine stage that is suitable for implementations using FPGAs known in the art. In some aspects, the adapted TDC-approach can be combined with correlation receiver concepts allowing for a more robust signal detection (e.g., in the presence of strong background noise). Multi-hit capabilities can be added.

Byway of illustration, the proposed architecture essentially adopts a TDC scheme not only to determine the time-of-flight but also to capture amplitude and pulse-shape information provided by an array of comparators. The solution may be illustratively divided in the following stages: (1) quantization stage (e.g., the quantization stage 120, 220): an array of parallel comparators may be used to quantify the amplitude of the detected signal (one of the comparators may be also used to create the signal that is used to stop the ToF measurement).

(2) Encoding stage (differentiation, e.g. the encoding stage 130, 230): the quantified signal is encoded by differentiation, e.g. the differential increments and decrements found in the quantified signal are encoded in a suitable way. (3) Signal capturing stage using TDC (e.g., the digitalization stage 140, 240): the encoded signal is captured using two parallel TDC stages, possibly realized by a tapped delay line, that are capable to capture high-speed signals in sub-nanosecond scale.

Alternatively, also a single TDC stage may be used. The TDC stage(s) may be implemented by delay lines or other means known for implementing TDCs. (4) Signal reconstruction (Integration or Inference): using the captured signal the pulse-shape can be reconstructed or inferred. In the case of two parallel TDC stages this can be accomplished by simple integration of the captured, differentiated signal. In the case of a single TDC stage the pulse-shape can be inferred using knowledge about typical LIDAR pattern as side-information. (5) ToF refinement stage: the derived pulse-shape can be used to refine the ToF in order to reduce the walk error either by an offset calculation, or by adopting correlation receiver concepts.

Received LIDAR detected signals typically can be categorized with a few coarse measurements only. Finding meaningful categories for LIDAR detected signals may be application dependent. An example for pulse-shape categories that were found in order to draw conclusions about the object's pulse-shape properties was provided in FIG. 3A to FIG. 3D. Other meaningful ways to categorize LIDAR detected signals may include the weather condition, or take into account other external factors, like the ambient light level. Usually the number of categories that is needed is relatively small. Particularly considering categories that were found based on the pulse-shape, it is safe to assume that pulses within different categories have distinct features that allow the system to tell them apart from each other. This essentially means that a few coarse measurements are usually sufficient to identify the category of a given pulse.

In the following, various aspects of this disclosure will be illustrated.

Example 1 is a detection system including: a detector configured to provide a received signal; and a processing circuit configured to: provide a plurality of quantized signals, each quantized signal being associated with a respective threshold level, and each quantized signal being representative of the portions of the received signal in which a signal level of the received signal is greater than the respective threshold level; provide an encoded signal based on the plurality of quantized signals, the encoded signal including a first plurality of first encoded signal values being representative of the portions of the received signal in which the signal level of the received signal becomes greater than one of the threshold levels, and including a second plurality of second encoded signal values being representative of the portions of the received signal in which the signal level of the received signal becomes less than one of the threshold levels; and perform a time-to-digital conversion of the encoded signal to provide a digitized signal, the digitized signal including a first plurality of first digitized values associated with the first encoded signal values, and including a second plurality of second digitized values associated with the second encoded signal values.

In Example 2, the detection system according to example 1 may optionally further include that the received signal is or includes a received light signal, and that the detection system is a light detection system.

In Example 3, the detection system according to example 1 or 2 may optionally further include that the processing circuit is configured to compare the signal level of the received signal with each threshold level to provide the plurality of quantized signals.

In Example 4, the detection system according to example 3 may optionally further include that the processing circuit includes a plurality of comparators each associated with a respective reference value, and that each comparator of the plurality of comparators is configured to provide a respective first output signal in case the signal level of the received signal is greater than the respective reference value and to provide a respective second output signal in case the signal level of the received signal is less than the respective reference value.

In Example 5, the detection system according to example 4 may optionally further include that the comparators of the plurality of comparators are connected in parallel with one another.

In Example 6, the detection system according to example 4 or 5 may optionally further include that reference values associated with different comparators of the plurality of comparators are linearly spaced from one another or logarithmically spaced from one another.

In Example 7, the detection system according to any one of examples 4 to 6 may optionally further include that the plurality of comparators include a first comparator associated with a first reference value, a second comparator associated with a second reference value, and a third comparator associated with a third reference value, that the third reference is greater than the second reference value, and that the second reference value is greater than the first reference value, and that a difference between the third reference value and the second reference value is equal to a difference between the second reference value and the first reference value.

In Example 8, the detection system according to any one of examples 4 to 7 may optionally further include that the plurality of quantized signals is a function of the respective output signals of the plurality of comparators.

In Example 9, the detection system according to any one of examples 4 to 8 may optionally further include that the plurality of comparators include at least one high-gain differential amplifier.

In Example 10, the detection system according to any one of examples 1 to 9 may optionally further include that the processing circuit is configured to provide a cumulated signal based on the plurality of quantized signals and to differentiate the cumulated signal to provide a cumulated differential signal, or that the processing circuit is configured to differentiate the quantized signals of the plurality of quantized signals to provide a plurality of differential signals and to provide a cumulated differential signal by using the plurality of differential signals.

In Example 11, the detection system according to any one of examples 4 to 10 may optionally further include that the processing circuit is configured to sum the output signals of the plurality of comparators to provide the cumulated signal, or that the processing circuit is configured to sum the differential signals to provide the cumulated differential signal.

In Example 12, the detection system according to example 11 may optionally further include that the processing circuit includes at least one operational amplifier configured to receive the output signals of the plurality of comparators and to sum the output signals with one another.

In Example 13, the detection system according to any one of examples 10 to 12 may optionally further include that the processing circuit is configured to differentiate the cumulated signal by assigning a first differential value to the portions of the cumulated signal where the cumulated signal is increasing, and a second differential value to the portions of the cumulated signal where the cumulated signal is decreasing.

In Example 14, the detection system according to example 13 may optionally further include that the processing circuit is further configured to differentiate the cumulated signal by assigning a third differential value to the portions of the aggregate signal where the cumulated signal is substantially flat.

In Example 15, the detection system according to any one of examples 10 to 14 may optionally further include that the processing circuit includes a high-pass filter configured to receive the cumulated signal and output the cumulated differential signal, or that the processing circuit includes a plurality of high-pass filters configured to receive the plurality of quantized signals and output the a respective plurality of differential signals.

In Example 16, the detection system according to any one of examples 10 to 15 may optionally further include that the cumulated differential signal includes one or more first differential values and one or more second differential values, and that the one or more first differential values have an opposite polarity with respect to the one or more second differential values.

In Example 17, the detection system according to example 16 may optionally further include that the one or more first differential values have a positive polarity, and that the one or more second differential values have a negative polarity.

In Example 18, the detection system according to example 16 or 17 may optionally further include that the processing circuit is configured to assign a first combination of binary symbols to each first differential value, a second combination of binary symbols to each second differential value, and a third combination of binary symbols to each third differential value.

In Example 19, the detection system according to example 18 or 17 may optionally further include that providing the encoded signal includes providing a sequence including the first combinations of binary symbols, the second combinations of binary symbols, and the third combinations of binary symbols.

In Example 20, the detection system according to any one of examples 10 to 19 may optionally further include that providing the encoded signal includes rectifying the cumulated differential signal.

In Example 21, the detection system according to example 20 may optionally further include that the processing circuit includes one or more rectifying diodes configured to receive the cumulated differential signal and output the encoded signal.

In Example 22, the detection system according to example 20 or 21 may optionally further include that the first encoded signal values are associated with the one or more first differential values and that the second encoded signal values are associated with the one or more second differential values.

In Example 23, the detection system according to example 22 may optionally further include that the first encoded signal values form a first unipolar signal including the rectified one or more first differential values, that the second encoded signal values form a second unipolar signal including the rectified one or more second differential values, and that the rectified one or more first differential values have a same polarity as the rectified one or more second differential values.

In Example 24, the detection system according to example 23 may optionally further include that the rectified one or more first differential values and the rectified one or more second differential values have a positive polarity.

In Example 25, the detection system according to any one of examples 22 to 24 may optionally further include that the processing circuit is configured to delay the first unipolar signal and the second unipolar signal with respect to one another.

In Example 26, the detection system according to any one of examples 22 to 25 may optionally further include that performing the time-to-digital conversion of the encoded signal includes converting the first unipolar signal into a first digitized signal, the first digitized signal including the first digitized values and that performing the time-to-digital conversion of the encoded signal includes converting the second unipolar signal into a second digitized signal, the second digitized signal including the second digitized values.

In Example 27, the detection system according to any one of examples 1 to 26 may optionally further include that the processing circuit includes one or more time-to-digital conversion stages configured to receive the encoded signal and to perform the time-to-digital conversion of the encoded signal.

In Example 28, the detection system according to examples 4 and 27 may optionally further include that at least one time-to-digital conversion stage carrying out the time-to-digital conversion of the encoded signal may be associated with all the comparators of the plurality of comparators.

In Example 29, the detection system according to example 27 or 28 may optionally further include that the one or more time-to-digital conversion stages include at least a first time-to-digital conversion stage and a second time-to-digital conversion stage operating in parallel with one another.

In Example 30, the detection system according to any one of examples 27 to 29 may optionally further include that at least one time-to-digital conversion stage of the one or more time-to-digital conversion stages includes a tapped delay line.

In some aspects, the one or more time-to-digital conversion stages include at least one of an application-specific integrated circuit (ASIC), a field programmable array (FPGA), or a FPGA-based tapped delay line.

In Example 31, the detection system according to example 30 may optionally further include that the tapped delay line includes a plurality of D-flip-flops and a plurality of delay elements, and that each delay element of the plurality of delay elements is associated with a respective D-flip-flop of the plurality of D-flip-flops.

In Example 32, the detection system according to any one of examples 1 to 31 may optionally further include that the processing circuit is configured to determine amplitude information associated with the received signal by combining the one or more first digitized values with the one or more second digitized values.

In Example 33, the detection system according to example 32 may optionally further include that the one or more first digitized values have a first logic value in correspondence of the portions where the signal level of the received signal becomes greater than one of the threshold levels associated with the quantized signals, and a second logic value in correspondence of the remaining portions of the received signal, and that the one or more second digitized values have the first logic value in correspondence of the portions where the signal level of the received signal becomes less than one of the threshold levels associated with the quantized signals, and the second logic value in correspondence of the remaining portions of the received signal.

In Example 34, the detection system according to example 33 may optionally further include that the first logic value is a logic 1 and the second logic value is a logic 0.

In Example 35, the detection system according to example 33 or 34 may optionally further include that the processing circuit is configured to determine amplitude information associated with the received signal by combining the one or more first digitized values with the one or more second digitized values to provide a cumulated summation signal.

In Example 36, the detection system according to example 35 may optionally further include that providing the cumulated summation signal includes incrementing a cumulated signal value in correspondence of each first logic value of the one or more first digitized values and decrementing the cumulated signal value in correspondence of each first logic value of the one or more second digitized values.

In Example 37, the detection system according to example 36 may optionally further include that the processing circuit is configured to determine amplitude information associated with the received signal by assigning to each cumulated signal value one reference value of the plurality of reference values associated with the plurality of comparators.

In Example 38, the detection system according to any one of examples 35 to 37 may optionally further include that the processing circuit is configured to reconstruct the shape of the received signal by using at least one of the digitized signal and/or the cumulated summation signal.

In Example 39, the detection system according to example 38 may optionally further include that the processing circuit is configured to reconstruct the shape of the received signal by comparing the cumulated summation signal to a plurality of known cumulated summation signals. Additionally or alternatively, the processing circuit may be configured to reconstruct the shape of the received signal by comparing the digitized signal to a plurality of known digitized signals.

In Example 40, the detection system according to any one of examples 1 to 39 may optionally further include that the processing circuit is configured to determine a time-of-flight associated with the received signal.

In Example 41, the detection system according to example 40 may optionally further include that the processing circuit is configured to receive a clock signal and to determine the time-of-flight associated with the received signal in accordance with the clock signal.

In Example 42, the detection system according to example 40 or 41 may optionally further include that the processing circuit is configured to receive a start signal indicative of a start of an emission of the received signal, and to determine the time-of-flight associated with the received signal in accordance with the start signal.

In Example 43, the detection system according to any one of examples 40 to 42 may optionally further include that the processing circuit is configured to determine the time-of-flight associated with the received signal by using the output signal of at least one comparator of the plurality of comparators.

In Example 44, the detection system according to example 43 may optionally further include that the processing circuit is configured to use the output signal of the at least one comparator as a stop signal for stopping a time-of-flight measurement.

In Example 45, the detection system according to example 43 or 44 may optionally further include that the reference value associated with the at least one comparator is the smallest reference value among the reference values associated with the plurality of comparators.

In Example 46, the detection system according to any one of examples 40 to 45 may optionally further include that the processing circuit includes at least a coarse time-to-digital conversion stage configured to provide a coarse measurement duration of the time-of-flight associated with the received signal, and a fine time-to-digital conversion stage configured to provide a fine measurement duration of the time-of-flight associated with the received signal.

In Example 47, the detection system according to example 46 may optionally further include that the coarse time-to-digital conversion stage is configured to provide a coarse time measurement duration based on an integer number of clock cycles of the clock signal. For example, the coarse time measurement duration may include an integer number of clock cycles between the start signal and the stop signal.

In Example 48, the detection system according to example 46 or 47 may optionally further include that the fine time-to-digital conversion stage is configured to provide a fine time measurement duration based on the stop signal and a reference point of the clock signal. For example, the reference point of the clock signal includes a positive edge or a negative edge of the clock cycle subsequent to the stop signal.

In Example 49, the detection system according to any one of examples 46 to 48 may optionally further include that the processing circuit is configured to determine the time-of-flight based on the coarse time measurement duration and the fine time measurement duration. For example, the processing circuit may be configured to determine the time-of-flight as the difference between the coarse time measurement duration and the fine time measurement duration.

In Example 50, the detection system according to any one of examples 46 to 49 may optionally further include that the processing circuit is configured to continue capturing the received signal for a predefined time period after the stop signal.

In Example 51, the detection system according to example 50 may optionally further include that the predefined time period includes the fine time measurement duration and a predefined number of clock cycles of the clock signal.

In Example 52, the detection system according to any one of examples 40 to 51 may optionally further include that the processing circuit is configured to adjust a result of the time-of-flight measurement by using the reconstructed shape of the received signal.

In Example 53, the detection system according to example 52 may optionally further include that the processing circuit is configured to identify one or more relevant portions in the reconstructed shape of the received signal based on a known shape of the received signal, and to determine one or more respective time offsets between the start of the time-of-flight measurement and each of the one or more relevant portions.

In Example 54, the detection system according to example 53 may optionally further include that the processing circuit is configured to adjust the result of the time-of-flight measurement by using the one or more determined time offsets.

In Example 55, the detection system according to any one of examples 40 to 54 may optionally further include that the processing circuit is configured to adapt the threshold levels associated with the quantized signals based on at least one of: a time-of-flight associated with the received signal, a reconstructed shape of the received signal, and/or one or more environmental conditions.

In Example 56, the detection system according to any one of examples 1 to 55 may optionally further include that the processing circuit includes at least one of an application-specific integrated circuit (ASIC), a discrete digital circuit, a multi-purpose field programmable array (FPGA), a microcontroller, or a microprocessor.

In Example 57, the detection system according to any one of examples 2 to 56 may optionally further include that the detector is configured to receive a light signal and provide the received signal representing the received light signal

In Example 58, the detection system according to example 57 may optionally further include that the detector includes at least one photo diode configured to generate an analog signal in response to a light signal impinging onto the at least one photo diode.

In Example 59, the detection system according to example 58 may optionally further include that the at least one photo diode includes at least one of a PIN photo diode, an avalanche photo diode, or a silicon photomultiplier.

In Example 60, the detection system according to example 58 or 59 may optionally further include that the detector includes an amplifier circuit configured to amplify the analog signal generated by the at least one photo diode.

In Example 61, the detection system according to example 60 may optionally further include that the analog signal generated by the at least one photo diode is an analog signal of a first type, and the amplifier circuit is configured to convert the analog signal of the first type into an analog signal of a second type.

In Example 62, the detection system according to example 61 may optionally further include that the analog signal of the first type is or includes a current, and that the analog signal of the second type is or includes a voltage.

In Example 63, the detection system according to any one of examples 60 to 62 may optionally further include that the amplifier circuit includes at least one of a logarithmic amplifier, a transimpedance amplifier, or a logarithmic transimpedance amplifier.

According to one or more of the above examples, the processing circuit may include one or more correlation receivers, each correlation receiver being associated with a respective reference signal sequence (e.g., with at least one respective reference signal sequence of one or more reference signal sequences), each correlation receiver being configured to correlate at least one of the digitized signal and/or the cumulated summation signal with the respective reference signal sequence to provide a respective correlation output (e.g., a respective one of one or more correlation outputs). The processing circuit may be configured to (jointly) use the one or more correlation outputs (provided by the one or more correlation receivers) to compare the digitized signal and/or the cumulated summation signal with (each of) the one or more reference signal sequences, and the processing circuit may be configured to, based on the result of the comparison, determine amplitude information associated with the received signal, and/or reconstruct the shape of the received signal, and/or determine a time-of-flight associated with the received signal (illustratively, based on the correlation between the digitized signal and the one or more reference signal sequences and/or based on the correlation between the cumulated summation signal and the one or more reference signal sequences).

Example 64 is a LIDAR system including a light emission system configured to emit a light signal; and the light detection system according to any one of examples 2 to 63 configured to receive the emitted light signal.

In Example 65, the LIDAR system according to example 64 may optionally further include that the LIDAR system further includes a clock signal generator configured to generate a clock signal, and that the clock signal generator is configured to provide a common clock signal to the light emission system and the light detection system.

In Example 66, the LIDAR system according to example 64 or 65 may optionally further include that the light emission system includes: a light source; and a light source driver configured to control an emission of light by the light source.

In Example 67, the LIDAR system according to example 66 may optionally further include that the light source driver is configured to control the light emission by the light source in accordance with the common clock signal.

In Example 68, the LIDAR system according to example 67 may optionally further include that the light source driver is configured to control a light emission by the light source in synchronization with the common clock signal.

In Example 69, the LIDAR system according to example 68 may optionally further include that the light source driver is configured to control the light emission by the light source in response to a start signal received at the light source driver, and that the start signal is synchronized with the common clock signal.

In Example 70, the LIDAR system according to example 69 may optionally further include that a rising edge of the start signal is synchronized with a rising edge of the common clock signal.

In Example 71, the LIDAR system according to any one of examples 64 to 70 may optionally further include that the light source includes an optoelectronic light source.

In Example 72, the LIDAR system according to example 71 may optionally further include that the light source includes at least one of one or more light emitting diodes or one or more laser diodes.

In Example 73, the LIDAR system according to example 72 may optionally further include that the light source includes one or more vertical cavity surface emitting laser diodes and/or one or more edge emitting laser diodes.

In Example 74, the LIDAR system according to any one of examples 64 to 73 may optionally further include that the light source driver is configured to control the light emission by the light source in accordance with the amplitude and/or shape information provided by the light detection system.

In Example 75, the LIDAR system according to example 74, may optionally further include that the light source driver is configured to control the light source to emit a further light signal having increased optical power in case the amplitude information provided by the light detection system indicates that the amplitude of the received light signal is less than a predefined threshold. Example 76 is a detection system including: a detector configured to provide a received signal; and a processing circuit configured to: encode the shape of the received signal, based on the slope of the received signal, to provide an encoded signal, the encoded signal including a first plurality of first encoded signal values being representative of the portions of the received signal in which a slope of a tangent to the received signal is positive, and a second plurality of second encoded signal values being representative of the portions of the received signal in which the slope of the tangent to the received signal is negative; and perform a time-to-digital conversion of the encoded signal to provide a digitized signal, the digitized signal including one or more first digitized values associated with the first encoded signal values, and including one or more second digitized values associated with the second encoded signal values.

Example 77 is the detection system according to example 76 including one, or some, or all the features of the detection system according to any one of examples 1 to 63.

Example 78 is a detection system including: a detector configured to provide a received signal; and a processing circuit configured to: perform, based on a plurality of threshold levels, a signal level-to-time conversion of the received signal to provide an encoded signal, the encoded signal including a first plurality of first encoded signal values being representative of the portions of the received signal in which a signal level of the received signal becomes greater than one threshold level of the plurality of threshold levels, and including a second plurality of second encoded signal values being representative of the portions of the received signal in which the signal level of the received signal becomes less than one threshold level of the plurality of threshold levels; and perform a time-to-digital conversion of the encoded signal to provide a digitized signal, the digitized signal including one or more first digitized values associated with the first encoded signal values, and including one or more second digitized values associated with the second encoded signal values.

Example 79 is the detection system according to example 76 including one, or some, or all the features of the detection system according to any one of examples 1 to 63.

Example 80 is a LIDAR system including the detection system according to any one of examples 1 to 63.

Example 81 is a method of detecting a signal, the method including: providing a received signal; providing a plurality of quantized signals, each quantized signal being associated with a respective threshold level, and each quantized signal being representative of the portions of the received signal in which a signal level of the received signal is greater than the respective threshold level associated with the quantized signal; providing an encoded signal based on the plurality of quantized signals, the encoded signal including a first plurality of first encoded signal values being representative of the portions of the received signal in which the signal level of the received signal becomes greater than one of the threshold levels associated with the quantized signals, and including a second plurality of second encoded signal values being representative of the portions of the received signal in which the signal level of the received signal becomes less than one of the threshold levels associated with the quantized signals; and performing a time-to-digital conversion of the encoded signal to provide a digitized signal, the digitized signal including one or more first digitized values associated with the first encoded signal values, and including one or more second digitized values associated with the second encoded signal values.

Example 82 is the method according to example 81 including one, or some, or all the features of the detection system according to any one of examples 1 to 63, adapted accordingly.

While various implementations have been particularly shown and described with reference to specific aspects, it should be understood by those skilled in the art that various changes in form and detail may be made therein without departing from the spirit and scope as defined by the appended claims. The scope is thus indicated by the appended claims and all changes which come within the meaning and range of equivalency of the claims are therefore intended to be embraced.

1-15. (canceled)

16. A detection system comprising:
a detector configured to provide a received signal; and
a processing circuit configured to:
provide a plurality of quantized signals, each quantized signal being associated with a respective threshold level, and each quantized signal being representative of portions of the received signal in which a signal level of the received signal is greater than the respective threshold level;
provide an encoded signal based on the plurality of quantized signals, the encoded signal comprising a first plurality of first encoded signal values being representative of the portions of the received signal in which the signal level of the received signal becomes greater than one of the threshold levels and a second plurality of second encoded signal values being representative of the portions of the received signal in which the signal level of the received signal becomes less than one of the threshold levels; and
perform a time-to-digital conversion of the encoded signal to provide a digitized signal, the digitized signal comprising a first plurality of first digitized values associated with the first encoded signal values, and a second plurality of second digitized values associated with the second encoded signal values.

17. The detection system according to claim 16,
wherein the received signal comprises a received light signal, and
wherein the detection system is a light detection system.

18. The detection system according to claim 16, wherein the processing circuit is configured to compare the signal level of the received signal with each threshold level to provide the plurality of quantized signals.

19. The detection system according to claim 18,
wherein the processing circuit comprises a plurality of comparators each associated with a respective reference value, and
wherein each comparator of the plurality of comparators is configured to provide a respective first output signal in case the signal level of the received signal is greater than the respective reference value and to provide a respective second output signal in case the signal level of the received signal is less than the respective reference value.

20. The detection system according to claim 19, wherein the processing circuit is configured to determine a time-of-flight associated with the received signal by using an output signal of at least one comparator of the plurality of comparators.

21. The detection system according to claim 16,
wherein the processing circuit is configured to provide a cumulated signal based on the plurality of quantized signals and to differentiate the cumulated signal to provide a cumulated differential signal, or
wherein the processing circuit is configured to differentiate the quantized signals of the plurality of quantized signals to provide a plurality of differential signals and to provide a cumulated differential signal by using the plurality of differential signals.

22. The detection system according to claim 21,
wherein the processing circuit is configured to sum output signals of the plurality of comparators to provide the cumulated signal, or
wherein the processing circuit is configured to sum the differential signals to provide the cumulated differential signal.

23. The detection system according to claim 21, wherein the processing circuit is configured to differentiate the cumulated signal by assigning a first differential value to the portions of the cumulated signal where the cumulated signal is increasing, and a second differential value to the portions of the cumulated signal where the cumulated signal is decreasing.

24. The detection system according to claim 21,
wherein providing the encoded signal comprises rectifying the cumulated differential signal,
wherein the first encoded signal values form a first unipolar signal comprising rectified one or more first differential values,
wherein the second encoded signal values form a second unipolar signal comprising rectified one or more second differential values.

25. The detection system according to claim 24,
wherein performing the time-to-digital conversion of the encoded signal comprises converting the first unipolar signal into a first digitized signal, the first digitized signal comprising the first digitized values and
wherein performing the time-to-digital conversion of the encoded signal comprises converting the second unipolar signal into a second digitized signal, the second digitized signal comprising the second digitized values.

26. The detection system according to claim 16, wherein the processing circuit is configured to determine amplitude information associated with the received signal by combining the one or more first digitized values with the one or more second digitized values to provide a cumulated summation signal.

27. The detection system according to claim 26,
wherein the processing circuit is configured to reconstruct a shape of the received signal by using at least one of the digitized signal and/or the cumulated summation signal, or
wherein the processing circuit is configured to reconstruct the shape of the received signal by comparing the digitized signal to a plurality of known digitized signals and/or by comparing the cumulated summation signal to a plurality of known cumulated summation signals.

28. The detection system according to claim 16,
wherein the processing circuit comprises one or more correlation receivers,
wherein each correlation receiver is associated with a respective reference signal sequence,
wherein each correlation receiver is configured to correlate at least one of the digitized signal and/or a cumulated summation signal with the respective reference signal sequence to provide a respective correlation output,
wherein the processing circuit is configured to use the one or more correlation outputs to compare the digitized signal and/or the cumulated summation signal with the one or more reference signal sequences, and
wherein the processing circuit is configured, based on a result of a comparison, to determine amplitude information associated with the received signal, and/or to reconstruct a shape of the received signal, and/or to determine a time-of-flight associated with the received signal.

29. A LIDAR system comprising:
a light emission system configured to emit a light signal; and
the detection system according to claim 16 configured to receive the emitted light signal.

30. A method for detecting a signal, the method comprising:
providing a received signal;
providing a plurality of quantized signals, each quantized signal being associated with a respective threshold level, and each quantized signal being representative of portions of the received signal in which a signal level of the received signal is greater than the respective threshold level associated with the quantized signal;
providing an encoded signal based on the plurality of quantized signals, the encoded signal comprising a first plurality of first encoded signal values being representative of the portions of the received signal in which the signal level of the received signal becomes greater than one of the threshold levels associated with the quantized signals, and comprising a second plurality of second encoded signal values being representative of the portions of the received signal in which the signal level of the received signal becomes less than one of the threshold levels associated with the quantized signals; and
performing a time-to-digital conversion of the encoded signal to provide a digitized signal, the digitized signal comprising one or more first digitized values associated with the first encoded signal values, and comprising one or more second digitized values associated with the second encoded signal values.
